(19) United States
(12) Patent Application Publication
(10) Pub. No.: US 2018/0001442 A1
(43) Pub. Date: Jan. 4, 2018

(54) COATED ABRASIVE ARTICLES AND METHODS FOR FORMING SAME

(71) Applicant: SAINT-GOBAIN CERAMICS & PLASTICS, INC., Worcester, MA (US)

(72) Inventors: Doruk O. YENER, Bedford, MA (US); Ralph BAUER, Niagara Falls (CA); Jennifer H. CZEREPINSKI, Framingham, MA (US); Darrell K. EVERTS, Schenectady, NY (US)

(21) Appl. No.: 15/636,415

(22) Filed: Jun. 28, 2017

Related U.S. Application Data
(60) Provisional application No. 62/356,490, filed on Jun. 29, 2016.

(51) Int. Cl. B24D 3/06; B24D 11/02; B24D 3/34; B82Y 30/00; C09K 3/14; C01F 7/02

(52) U.S. Cl. CPC B24D 3/06; C09K 3/1445; C01F 7/023; B24D 3/34; B82Y 30/00; B24D 11/02; C01P 2002/60

(57) ABSTRACT

A coated abrasive article having a substrate, a bond material overlying the substrate, and a layer of abrasive particles contained within the bond material, the abrasive particles comprising nanocrystalline alumina.

### CROSS-REFERENCE TO RELATED APPLICATION(S)

This application claims priority under 35 U.S.C. §119(e) to U.S. Provisional Patent Application No. 62/356,490, entitled “COATED ABRASIVE ARTICLES AND METHODS FOR FORMING SAME,” by Doruk O. YENER et al., filed Jun. 29, 2016, which is assigned to the current assignee hereof and incorporated herein by reference in its entirety.

### BACKGROUND OF THE INVENTION

### Field of the Disclosure

The present invention relates in general to abrasive articles and, in particular, to coated abrasive articles including nanocrystalline alumina.

### Description of the Related Art

Abrasive particles and abrasive articles made from abrasive particles are useful for various material removal operations including grinding, finishing, and polishing. Depending upon the type of abrasive material, such abrasive particles can be useful in shaping or grinding a wide variety of materials and surfaces in the manufacturing of goods. Certain types of abrasive particles have been formulated to date that have particular geometries, such as triangular shaped abrasive particles and abrasive articles incorporating such objects. See, for example, U.S. Pat. Nos. 5,201,916, 5,366,523, and 5,984,988.

Three basic technologies that have been employed to produce abrasive particles having a specified shape are (1) fusion, (2) sintering, and (3) chemical ceramic. In the fusion process, abrasive particles can be shaped by a chill roll, the face of which may or may not be engraved, a mold into which molten material is poured, or a heat sink material immersed in an aluminum oxide melt. See, for example, U.S. Pat. No. 3,377,660 (disclosing a process including flowing molten abrasive material from a furnace onto a cool rotating casting cylinder, rapidly solidifying the material to form a thin semisolid curved sheet, densifying the semisolid material with a pressure roll, and then partially fracturing the strip of semisolid material by reversing its curvature by pulling it away from the cylinder with a rapidly driven cooled conveyor).

In the sintering process, abrasive particles can be formed from refractory powders having a particle size of up to 10 micrometers in diameter. Binders can be added to the powders along with a lubricant and a suitable solvent, e.g., water. The resulting mixture, mixtures, or slurries can be shaped into platelets or rods of various lengths and diameters. See, for example, U.S. Pat. No. 3,079,242 (disclosing a method of making abrasive particles from calcined bauxite material including (1) reducing the material to a fine powder, (2) compacting under affirmative pressure and forming the fine particles of said powder into grain sized agglomerations, and (3) sintering the agglomerations of particles at a temperature below the fusion temperature of the bauxite to induce limited recrystallization of the particles, whereby abrasive grains are produced directly to size).

Chemical ceramic technology involves converting a colloidal dispersion or hydrosol (sometimes called a sol), optionally in a mixture, with solutions of other metal oxide precursors, into a gel or any other physical state that restrains the mobility of the components, drying, and firing to obtain a ceramic material. See, for example, U.S. Pat. Nos. 4,744,802 and 4,848,041.

Still, there remains a need in the industry for improving performance, life, and efficacy of abrasive particles, and the abrasive articles that employ abrasive particles.

### BRIEF DESCRIPTION OF THE DRAWINGS

Embodiments are illustrated by way of example and are not limited in the accompanying figures.

FIG. 1A includes a flow chart for forming a coated abrasive article.

FIG. 1B includes a cross-sectional illustration of a coated abrasive article according to an embodiment.

FIG. 2 includes perspective view of a shaped abrasive particle in accordance with an embodiment.

FIG. 3A includes a perspective view of a shaped abrasive particle in accordance with an embodiment.

FIG. 3B includes a perspective view of a non-shaped abrasive particle according to an embodiment.

FIG. 4A-4C include top-down illustrations of shaped abrasive particles according to embodiments.

FIG. 5 includes images representative of portions of a coated abrasive according to an embodiment and used to analyze the orientation of shaped abrasive particles on the backing.

FIG. 6A includes a SEM image of conventional microcrystalline alumina grains.

FIG. 6B includes a SEM image of nanocrystalline alumina grains in accordance with an embodiment.

FIG. 7 includes a top view illustration of a portion of a coated abrasive article including abrasive particles having predetermined positions and controlled orientation according to an embodiment

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other teachings can certainly be used in this application.

As used herein, the terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single embodiment is described herein, more than one embodiment may be used in place of a single embodiment. Similarly, where more than one embodiment is described herein, a single embodiment may be substituted for that more than one embodiment.

Unless otherwise defined, all technical and scientific terms used herein have the same meaning as commonly understood by one of ordinary skill in the art to which this invention belongs. The materials, methods, and examples are illustrative only and not intended to be limiting. To the extent that certain details regarding specific materials and processing acts are not described, such details may include conventional approaches, which may be found in reference books and other sources within the manufacturing arts.

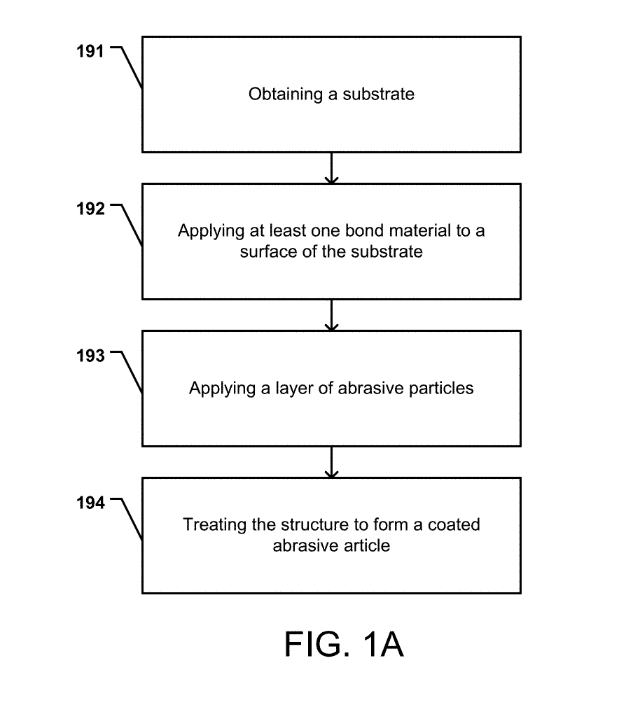

In one aspect, the present embodiments are directed to a method for forming a coated abrasive article. FIG. 1A includes a flow chart providing a process for forming a coated abrasive article according to an embodiment. FIG. 1B includes a cross-sectional illustration of a coated abrasive article according to an embodiment and may be referred to for reference to certain component described herein. As illustrated in FIG. 1A, the process is initiated at step 191 by obtaining a substrate or backing material onto which one or more bonding layers and a layer of abrasive particles can be attached. The substrate can provide a suitable structure for supporting and forming the coated abrasive article. As illustrated in FIG. 1B, the coated abrasive 100 can include a substrate 101 (i.e., a backing) and at least one bond material overlying a surface of the substrate 501.

According to one embodiment, the substrate 101 can include an organic material, inorganic material, and a combination thereof. In certain instances, the substrate 101 can include a woven material. However, the substrate 101 may be made of a non-woven material. Particularly suitable substrate materials can include organic materials, including polymers, and particularly, polyester, polyurethane, polypropylene, polyimides such as KAPTON from DuPont, paper. Some suitable inorganic materials can include metals, metal alloys, and particularly, foils of copper, aluminum, steel, and a combination thereof. According to one embodiment, the substrate can include a material selected from the group consisting of cloth, paper, film, fabric, fleeced fabric, vulcanized fiber, woven material, non-woven material, webbing, polymer, resin, phenolic resin, phenolic-latex resin, epoxy resin, polyester resin, urea formaldehyde resin, polyester, polyurethane, polypropylene, polyimides, and a combination thereof. Moreover, in another embodiment, the substrate may include an additive chosen from the group of catalysts, coupling agents, currants, anti-static agents, suspending agents, anti-loading agents, lubricants, wetting agents, dyes, fillers, viscosity modifiers, dispersants, defoamers, and grinding agents.

After obtaining the substrate at step 191 the process can continue at step 192 by applying at least one bond material to a surface of the substrate. The bond material can include one or more adhesive layers configured to bond to a major surface of the substrate. In at least one embodiment, the one or more adhesive layers can include a make coat 103 and/or a size coat 104. The one or more adhesive layers can include a polymer formulation. Any one of the adhesive layers may be formed using conventional techniques. Moreover, it will be appreciated that one or more of the adhesive layers can be formed simultaneously or separately. A polymer formulation may be used to form any of a variety of layers of the abrasive article such as, for example, a frontfill, a pre-size, the make coat, the size coat, and/or a supersize coat. When used to form the frontfill, the polymer formulation generally includes a polymer resin, fibrillated fibers (preferably in the form of pulp), filler material, and other optional additives. Suitable formulations for some frontfill embodiments can include material such as a phenolic resin, wollastonite filler, defoamer, surfactant, a fibrillated fiber, and a balance of water. Suitable polymeric resin materials include curable resins selected from thermally curable resins including phenolic resins, urea/formaldehyde resins, phenolic/latex resins, as well as combinations of such resins. Other suitable polymeric resin materials may also include radiation curable resins, such as those resins curable using electron beam, UV radiation, or visible light, such as epoxy resins, acrylated oligomers of acrylated epoxy resins, polyester resins, acrylated urethanes and polyester acrylates and acrylated monomers including monoacrylated, multiacrylated monomers. The formulation can also comprise a nonreactive thermoplastic resin binder which can enhance the self-sharpening characteristics of the deposited abrasive composites by enhancing the erodability. Examples of such thermoplastic resin include polypropylene glycol, polyethylene glycol, and polyoxypropylene-polyoxyethene block copolymer, etc. Use of a frontfill on the substrate 101 can improve the uniformity of the surface, for suitable application of the make coat 103 and may improve the application and orientation of abrasive particles 110 in a predetermined orientation.

In particular instances, the front fill layer can be in direct contact with a major surface, such as the upper major surface, of the substrate 101. More particularly, in certain instances, the front fill layer may be bonded directly to and abutting a major surface of the substrate, including for example, the upper major surface of the substrate 101.

The make coat 103 can be applied to the surface of the substrate 101 using conventional processes. Suitable materials of the make coat 103 can include organic materials, particularly polymeric materials, including for example, polyesters, epoxy resins, polyurethanes, polyamides, polyacrylates, polymethacrylates, polyvinyl chlorides, polyethylene, polysiloxane, silicones, cellulose acetates, nitrocellulose, natural rubber, starch, shellac, and mixtures thereof. In one embodiment, the make coat 103 can include a polyester resin. The coated substrate 101 can then be heated in order to cure the make coat 103 to the substrate 101. In general, the coated substrate 101 can be heated to a temperature of between about 100° C. to less than about 250° C. during the curing process.

After applying at least one bond material to a surface of the substrate 101, the process can continue at step 193 by applying a layer of abrasive particles 110. The process of applying the abrasive particles 110 may be completed using any deposition techniques known in the art, including but not limited to, electrostatic projection, gravity coating, pick-and-place, gravure rolling and the like. In certain instances, certain processes may be selected to control the placement of the abrasive particles 110, such that the abrasive particles have a controlled arrangement and/or controlled orientation on the substrate 101 as described in more detail in embodiments herein.

It will also be appreciated that the process of applying the layer of abrasive particles can be combined with other processes, such as the formation of one or more bond layers of the coated abrasive article. For example, it may be advantageous to create a mixture of the abrasive particles and bond material and simultaneous apply the mixture of abrasive particles and bond material to the substrate or a subassembly of the coated abrasive article (e.g., the substrate with one or more bond materials). In one embodiment, the abrasive particles 110 can be combined with the make coat 103 and applied as a mixture to the surface of the substrate 101. Any conventional deposition methods may be used to place the mixture of abrasive particles and bond material on the substrate or subassembly. Additionally, the layer of abrasive particles can be a single layer of abrasive particles 110, which is distinct from other fixed abrasive articles, such as bonded abrasive articles, that form a three-dimensional volume of bond material and the abrasive particles dispersed throughout the three-dimensional volume of the bond material. The make coat 103 can be overlying the surface of the substrate 101 and surrounding at least a portion of the abrasive particles 110.

The size coat 104 can be overlying and bonded to the abrasive particles 110 the make coat 103. Referring again to the process of forming, after sufficiently forming the make coat 103 with the abrasive particles 110, the size coat 104 can be formed to overlie and bond the abrasive particulate material 110 in place. The size coat 104 can include an organic material, may be made essentially of a polymeric material, and notably, can use polyesters, epoxy resins, polyurethanes, polyamides, polyacrylates, polymethacrylates, poly vinyl chlorides, polyethylene, polysiloxane, silicones, cellulose acetates, nitrocellulose, natural rubber, starch, shellac, and mixtures thereof. The size coat can be applied using any suitable processes, including conventional deposition processes. In certain instances, it may be desirable that the abrasive particles and the size coat are applied simultaneously, such that an initial mixture of the abrasive particles and size coat is made and then applied to the surface of the make coat. Still, in other instances, the size coat can be applied separately from the abrasive particles 110.

After applying the layer of abrasive particles and any suitable adhesive layers, the process can continue at step 194 by treating the structure to form a coated abrasive article. The process of treating can include curing the structure, which may include the application of heat, electromagnetic radiation (e.g., UV light) or a combination thereof. The curing process can facilitate changes in the one or more bond materials, which may include chemical changes (e.g., cross-linking), mechanical changes (e.g., hardening), or a combination thereof. According to one embodiment, the coated substrate 101 can then be heated in order to cure the size coat 104. Some suitable curing temperatures can be within a range of at least 100° C. to not greater than 250° C.

The abrasive particles 110 on the coated abrasive can be a batch and may include different portions of abrasive particles. According to one embodiment, the different portions of the abrasive particles in the batch may be present in different contents relative to each other. For example, the batch can include a first portion present in a first content and a second portion present in a second content, wherein the first content and the second content are different. The first portion can include any of the abrasive particles according to embodiments herein, including for example, but not limited to abrasive particles including nanocrystalline alumina. In one embodiment, the first portion may be present in a minority content (e.g., less than 50% and any whole number integer between 1% and 49%) of the total number of particles in a batch, a majority portion (e.g., 50% or greater and any whole number integer between 50% and 99%) of the total number of particles of the batch, or even essentially all of the particles of a batch (e.g., between 99% and 100%). In particular instances, the first portion may be present in an amount of at least about 1%, such as at least about 5%, at least about 10%, at least about 20%, at least about 30%, at least about 40%, at least about 50%, at least about 60%, at least about 70% at least 80% or at least 90% or at least 95% for the total content of abrasive particles within the batch. Still, in another embodiment, the batch may include not greater than about 99%, such as not greater than about 90% or not greater than about 80% or not greater than about 70% or not greater than about 60% or not greater than about 50% or not greater than about 40% or not greater than about 30% or not greater than about 20% or not greater than about 10% or not greater than about 8% or not greater than about 6% or or even not greater than about 4% of the total abrasive particles within the batch. The batch can include a content of the first portion within a range between any of the minimum and maximum percentages noted above.

The batch may also include a second portion of abrasive particles. The second portion of abrasive particles can include any of the abrasive particles described herein. For example, in one embodiment, the second portion can include diluent particles, which may be randomly shaped abrasive particles. Still, in another non-limiting embodiment, the second portion can include shaped abrasive particles, wherein the shaped abrasive particles of the second portion may differ in some characteristic from the abrasive particles of the first portion.

In certain instances, the batch may include a different content of the second portion relative to the first portion, and more particularly, may include a lesser content of the second portion relative to the content of the first portion. For example, the batch may contain a particular content of the second portion, including for example, not greater than about 45%, such as not greater than about 40% or not greater than 30% or not greater than about 20% or not greater than about 10% or not greater than about 8% or not greater than about 6% or even not greater than about 4% of the total content of abrasive particles in the batch. Still, in at least one non-limiting embodiment, the batch may contain at least about 0.5%, such as at least about 1% or at least about 2% or at least about 3% or at least about 4% or at least about 10% or at least about 15% or at least about 20% of the second portion for the total content of abrasive particles within the batch. It will be appreciated that the batch can contain a content of the second portion within a range between any of the minimum and maximum percentages noted above.

Still, in an alternative embodiment, the batch may include a greater content of the second portion relative to the first portion, and more particularly, can include a majority content of the second portion for the total content of abrasive particles in the batch. For example, in at least one embodiment, the batch may contain at least about 55%, such as at least about 60%, or at least 70% or at least 80% or at least 90% of the second portion for the total content of portions of the batch.

It will be appreciated that the batch can include additional portions, including for example a third portion. The third portion can be distinct from the first and second portions based on the content of abrasive particles within the third portion. Moreover, as will be described herein, the abrasive particles of the third batch may differ from the abrasive particles of the first and second batch based on at least one characteristic. The batch may include various contents of the third portion relative to the second portion and first portion. The third portion may be present in a minority amount or majority amount. In particular instances, the third portion may be present in an amount of not greater than about 40%, such as not greater than about 30%, not greater than about 20%, not greater than about 10%, not greater than about 8%, not greater than about 6%, or even not greater than about 4% of the total portion of abrasive particles within the batch. Still, in other embodiments the batch may include a minimum content of the third portion, such as at least about 1%, such as at least about 5%, at least about 10%, at least about 20%, at least about 30%, at least about 40%, or even at least about 50%. The batch can include a content of the third portion within a range between any of the minimum and maximum percentages noted above.

In another embodiment, the different portions can include different types of abrasive particles. For example, the abrasive particles 110 can include a first type of abrasive particles 105 defined by shaped abrasive particles 105 and a second type of abrasive particle 107. The different types of abrasive particles can differ from each other based upon at least characteristic selected from the group consisting of two-dimensional shape, average particle size, particle color, hardness, friability, toughness, density, specific surface area, or any combination thereof. It will be appreciated that the batch of abrasive particles can include more than two different portions and more than two different types of abrasive particles associated with each of the different portions. In certain instances, the second portion of the batch can include a plurality of shaped abrasive particles, wherein each of the shaped abrasive particles of the second portion can have substantially the same feature compared to each other, including but not limited to, for example, the same two-dimensional shape of a major surface. The second portion can have one or more features of the embodiments herein, which can be distinct compared to the plurality of shaped abrasive particles of the first portion.

The abrasive particles 110 can include different portions, wherein the different portions can include different types of abrasive particles that differ from each other on the basis of their shape (two-dimensional and/or three dimensional shape). In one embodiment, the coated abrasive article 100 can include a batch of abrasive particles 110 including at least two different shaped abrasive particles. In another embodiment, such as illustrated in FIG. 1B, the second type of abrasive particles 107 of the batch of abrasive particles 110 can be diluent particles. Diluent particles are typically abrasive particles having a lesser abrasive capabilities or cheaper compared to primary abrasive particles. Diluent particles may be randomly-shaped, abrasive particles made through conventional crushing processes.

Shaped abrasive particles are formed such that each particle has substantially the same arrangement of surfaces and edges relative to each other for shaped abrasive particles having the same two-dimensional and three-dimensional shapes. As such, shaped abrasive particles can have a high shape fidelity and consistency in the arrangement of the surfaces and edges relative to other shaped abrasive particles of the group having the same two-dimensional and three-dimensional shape. By contrast, non-shaped abrasive particles can be formed through different process and have different shape attributes. For example, non-shaped abrasive particles are typically formed by a comminution process, wherein a mass of material is formed and then crushed and sieved to obtain abrasive particles of a certain size. However, a non-shaped abrasive particle will have a generally random arrangement of the surfaces and edges, and generally will lack any recognizable two-dimensional or three-dimensional shape in the arrangement of the surfaces and edges around the body. Moreover, non-shaped abrasive particles of the same group or batch generally lack a consistent shape with respect to each other, such that the surfaces and edges are randomly arranged when compared to each other. Therefore, non-shaped grains or crushed grains have a significantly lower shape fidelity compared to shaped abrasive particles.

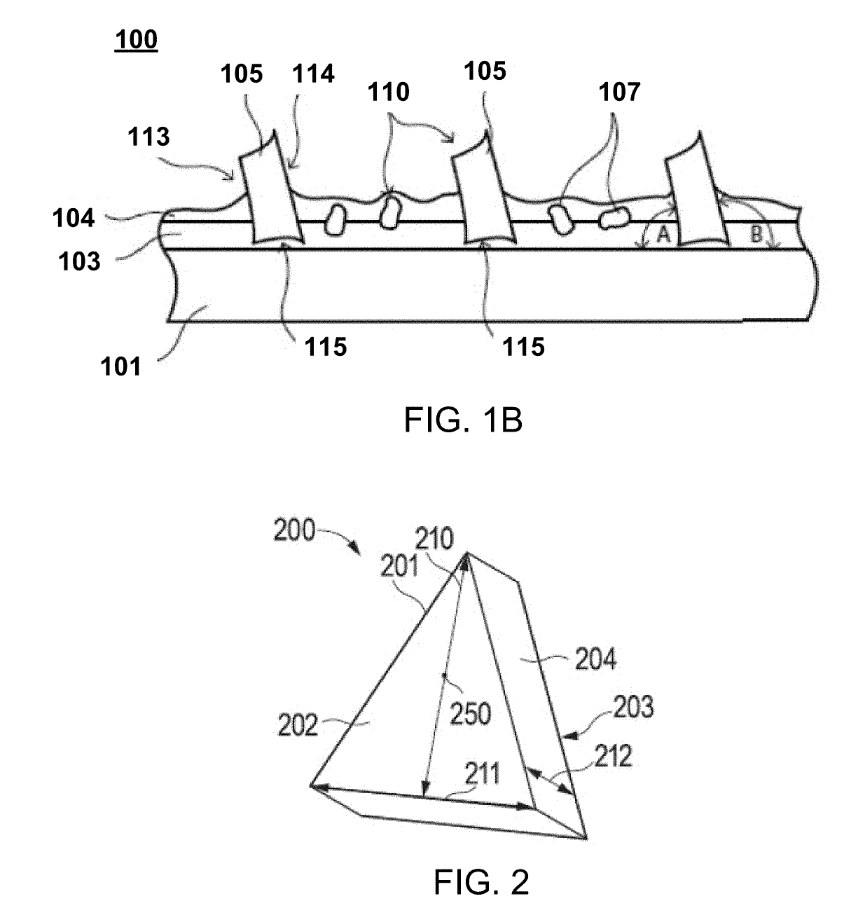

FIG. 2 includes a perspective view illustration of a shaped abrasive particle in accordance with an embodiment. The shaped abrasive particle 200 can include a body 201 including a major surface 202, a major surface 203, and a side surface 204 extending between the major surfaces 202 and 203. As illustrated in FIG. 2, the body 201 of the shaped abrasive particle 200 is a thin-shaped body, wherein the major surfaces 202 and 203 are larger than the side surface 204. Moreover, the body 201 can include a longitudinal axis 210 extending from a point to a base and through the midpoint 250 on the major surface 202. The longitudinal axis 210 can define the longest dimension of the major surface extending through the midpoint 250 of the major surface 202. The body 201 can further include a lateral axis 211 defining a width of the body 201 extending generally perpendicular to the longitudinal axis 210 on the same major surface 202. Finally, as illustrated, the body 201 can include a vertical axis 212, which in the context of thin shaped bodies can define a thickness (or height) of the body 201. For thin-shaped bodies, the length of the longitudinal axis 210 is equal to or greater than the vertical axis 212. As illustrated, the thickness 212 can extend along the side surface 204 between the major surfaces 202 and 203 and perpendicular to the plane defined by the longitudinal axis 210 and lateral axis 211. It will be appreciated that reference herein to length, width, and thickness of the abrasive particles may be reference to average values taken from a suitable sampling size of abrasive particles of a larger group, including for example, a group of abrasive particle affixed to a fixed abrasive.

The shaped abrasive particles of the embodiments herein, including thin shaped abrasive particles can have a primary aspect ratio of length:width such that the length of the body (Lb) can be greater than or equal to the width of the body (Wb). Furthermore, the length of the body (Lb) 201 can be greater than or equal to the thickness of the body (Tb). Finally, the width of the body (Wb) 201 can be greater than or equal to the thickness (Tb). In accordance with an embodiment, the primary aspect ratio of length:width can be at least 1:1, such as at least 1.1:1, at least 1.2:1, at least 1.5:1, at least 1.8:1, at least 2:1, at least 3:1, at least 4:1, at least 5:1, at least 6:1, or even at least 10:1. In another non-limiting embodiment, the body 201 of the shaped abrasive particle can have a primary aspect ratio of length:width of not greater than 100:1, not greater than 50:1, not greater than 10:1, not greater than 6:1, not greater than 5:1, not greater than 4:1, not greater than 3:1, not greater than 2:1, or even not greater than 1:1. It will be appreciated that the primary aspect ratio of the body 201 can be with a range including any of the minimum and maximum ratios noted above.

In another embodiment, the body 201 can have a secondary aspect ratio of length:thickness that can be at least 1.1:1, such as at least 1.2:1, at least 1.5:1, at least 1.8:1, at least 2:1, at least 3:1, at least 4:1, at least 5:1, at least 8:1, or even at least 10:1. Still, in another non-limiting embodiment, the secondary aspect ratio length:thickness of the body 201 can be not greater than 100:1, such as not greater than 50:1, not greater than 10:1, not greater than 8:1, not greater than 6:1, not greater than 5:1, not greater than 4:1, not greater than 3:1. It will be appreciated that the secondary aspect ratio the body 201 can be with a range including any of the minimum and maximum ratios and above.

Furthermore, the body 201 can have a tertiary aspect ratio of width:thickness that can be at least 1:1, such as at least 1.1:1, at least 1.2:1, at least 1.5:1, at least 1.8:1, at least 2:1, at least 3:1, at least 4:1, at least 5:1, at least 8:1, or even at least 10:1. Still, in another non-limiting embodiment, the tertiary aspect ratio width:thickness of the body 201 can be not greater than 100:1, such as not greater than 50:1, not greater than 10:1, not greater than 8:1, not greater than 6:1, not greater than 5:1, not greater than 4:1, not greater than 3:1, or even not greater than 2:1. It will be appreciated the tertiary aspect ratio of width:thickness can be with a range including any of the minimum and maximum ratios of above.

FIG. 2 includes an illustration of a shaped abrasive particle having a two-dimensional shape as defined by the plane of the upper major surface 202 or major surface 203, which has a generally triangular two-dimensional shape. It will be appreciated that the shaped abrasive particles of the embodiments herein are not so limited and can include other two-dimensional shapes. For example, the shaped abrasive particles of the embodiment herein can include particles having a body with a two-dimensional shape as defined by a major surface of the body from the group of shapes including polygons, irregular polygons, irregular polygons including arcuate or curved sides or portions of sides, ellipsoids, numerals, Greek alphabet characters, Latin alphabet characters, Russian alphabet characters, Kanji characters, complex shapes having a combination of polygons shapes, shapes including a central region and a plurality of arms (e.g., at least three arms) extending from a central region (e.g., star shapes), and a combination thereof. Particular polygonal shapes include rectangular, trapezoidal, quadrilateral, pentagonal, hexagonal, heptagonal, octagonal, nonagonal, decagonal, and any combination thereof. In another instance, the finally-formed shaped abrasive particles can have a body having a two-dimensional shape such as an irregular quadrilateral, an irregular rectangle, an irregular trapezoid, an irregular pentagon, an irregular hexagon, an irregular heptagon, an irregular octagon, an irregular nonagon, an irregular decagon, and a combination thereof. An irregular polygonal shape is one where at least one of the sides defining the polygonal shape is different in dimension (e.g., length) with respect to another side. As illustrated in other embodiments herein, the two-dimensional shape of certain shaped abrasive particles can have a particular number of exterior points or external corners. For example, the body of the shaped abrasive particles can have a two-dimensional polygonal shape as viewed in a plane defined by a length and width, wherein the body comprises a two-dimensional shape having at least 4 exterior points (e.g., a quadrilateral), at least 5 exterior points (e.g., a pentagon), at least 6 exterior points (e.g., a hexagon), at least 7 exterior points (e.g., a heptagon), at least 8 exterior points (e.g., an octagon), at least 9 exterior points (e.g., a nonagon), and the like.

It will be appreciated that the shaped abrasive particles of the embodiments herein can have a particular three-dimensional shape. Some examples of suitable three-dimensional shapes include a polyhedron, a pyramid, an ellipsoid, a sphere, a prism, a cylinder, a cone, a tetrahedron, a cube, a cuboid, a rhombohedrun, a truncated pyramid, a truncated ellipsoid, a truncated sphere, a truncated cone, a pentahedron, a hexahedron, a heptahedron, an octahedron, a nonahedron, a decahedron, a Greek alphabet letter, a Latin alphabet character, a Russian alphabet character, a Kanji character, complex polygonal shapes, irregular shaped contours, a volcano shape, a monostatic shape, or any a combination thereof. A monostatic shape is a shape with a single stable resting position.

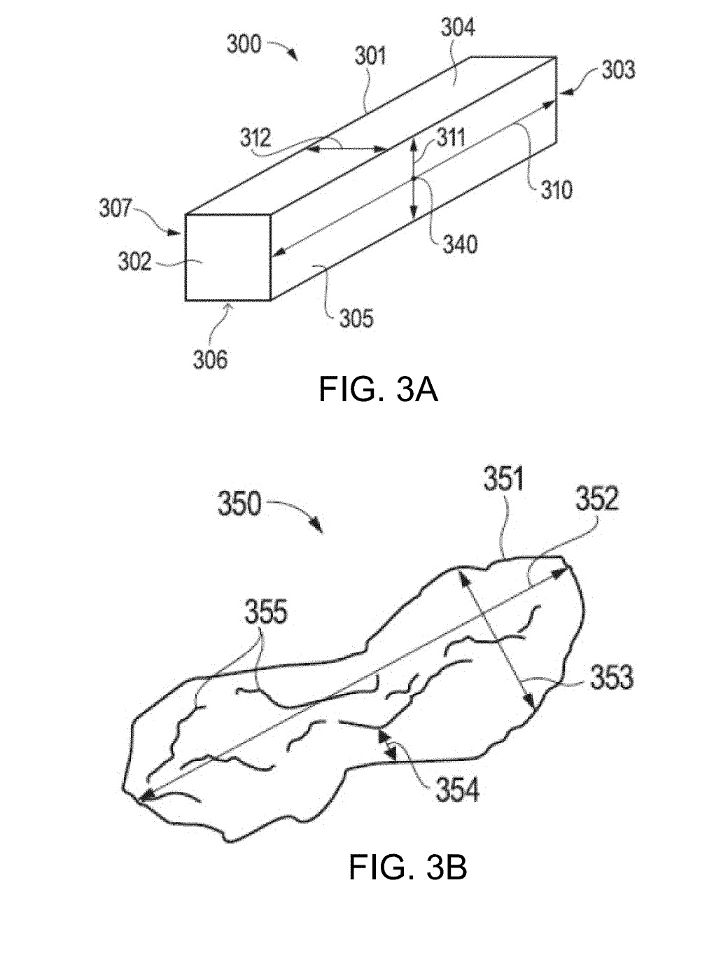

FIG. 3A includes a perspective view illustration of a shaped abrasive particle according to another embodiment. Notably, the shaped abrasive particle 300 can include a body 301 including a surface 302 and a surface 303, which may be referred to as end surfaces 302 and 303. The body can further include surfaces 304, 305, 306, 307 extending between and coupled to the end surfaces 302 and 303. The shaped abrasive particle of FIG. 3A is an elongated shaped abrasive particle having a longitudinal axis 310 that extends along the surface 305 and through the midpoint 340 between the end surfaces 302 and 303. It will be appreciated that the surface 305 is selected for illustrating the longitudinal axis 310, because the body 301 has a generally square cross-sectional contour as defined by the end surfaces 302 and 303. As such, the surfaces 304, 305, 306, and 307 have approximately the same size relative to each other. However in the context of other elongated abrasive particles, wherein the surfaces 302 and 303 define a different shape, for example, a rectangular shape, wherein one of the surfaces 304, 305, 306, and 307 may be larger relative to the others, the largest surface of those surfaces defines the major surface and therefore the longitudinal axis would extend along the largest of those surfaces. As further illustrated, the body 301 can include a lateral axis 311 extending perpendicular to the longitudinal axis 310 within the same plane defined by the surface 305. As further illustrated, the body 301 can further include a vertical axis 312 defining a thickness of the abrasive particle, were in the vertical axis 312 extends in a direction perpendicular to the plane defined by the longitudinal axis 310 and lateral axis 311 of the surface 305.

It will be appreciated that like the thin shaped abrasive particle of FIG. 2, the elongated shaped abrasive particle of FIG. 3A can have various two-dimensional shapes, such as those defined with respect to the shaped abrasive particle of FIG. 2. The two-dimensional shape of the body 301 can be defined by the shape of the perimeter of the end surfaces 302 and 303. The elongated shaped abrasive particle 300 can have any of the attributes of the shaped abrasive particles of the embodiments herein.

FIG. 3B includes an illustration of a non-shaped abrasive particle, which may be an elongated, non-shaped abrasive particle. It will be appreciated that the non-shaped abrasive particles of the embodiments herein may not necessarily be elongated, and may be more equiaxed. Shaped abrasive particles may be formed through particular processes, including molding, printing, casting, extrusion, and the like. Shaped abrasive particles are formed such that the each particle has substantially the same arrangement of surfaces and edges relative to each other. For example, a group of shaped abrasive particles generally have the same arrangement and orientation and or two-dimensional shape of the surfaces and edges relative to each other. As such, the shaped abrasive particles have a high shaped fidelity and consistency in the arrangement of the surfaces and edges relative to each other. By contrast, non-shaped abrasive particles can be formed through different process and have different shape attributes. For example, crushed grains are typically formed by a comminution process wherein a mass of material is formed and then crushed and sieved to obtain abrasive particles of a certain size. However, a non-shaped abrasive particle will have a generally random arrangement of the surfaces and edges, and generally will lack any recognizable two-dimensional or three dimensional shape in the arrangement of the surfaces and edges. Moreover, the non-shaped abrasive particles do not necessarily have a consistent shape with respect to each other and therefore have a significantly lower shape fidelity compared to shaped abrasive particles. The non-shaped abrasive particles generally are defined by a random arrangement of surfaces and edges with respect to each other.

As further illustrated in FIG. 3B, the abrasive article can be a non-shaped abrasive particle having a body 351 and a longitudinal axis 352 defining the longest dimension of the particle, a lateral axis 353 extending perpendicular to the longitudinal axis 352 and defining a width of the particle. Furthermore, the abrasive particle may have a thickness (or height) as defined by the vertical axis 354 which can extend generally perpendicular to a plane defined by the combination of the longitudinal axis 352 and lateral axis 353. As further illustrated, the body 351 of the non-shaped abrasive particle can have a generally random arrangement of edges 355 extending along the exterior surface of the body 351.

As will be appreciated, the abrasive particle can have a length defined by longitudinal axis 352, a width defined by the lateral axis 353, and a vertical axis 354 defining a thickness. As will be appreciated, the body 351 can have a primary aspect ratio of length:width such that the length is equal to or greater than the width. Furthermore, the length of the body 351 can be equal to or greater than or equal to the thickness. Finally, the width of the body 351 can be greater than or equal to the thickness 354. In accordance with an embodiment, the primary aspect ratio of length:width can be at least 1.1:1, at least 1.2:1, at least 1.5:1, at least 1.8:1, at least 2:1, at least 3:1, at least 4:1, at least 5:1, at least 6:1, or even at least 10:1. In another non-limiting embodiment, the body 351 of the elongated shaped abrasive particle can have a primary aspect ratio of length:width of not greater than 100:1, not greater than 50:1, not greater than 10:1, not greater than 6:1, not greater than 5:1, not greater than 4:1, not greater than 3:1, or even not greater than 2:1. It will be appreciated that the primary aspect ratio of the body 351 can be with a range including any of the minimum and maximum ratios noted above.

In another embodiment, the body 351 of the elongated abrasive particle 350 can have a secondary aspect ratio of length:thickness that can be at least 1.1:1, such as at least 1.2:1, at least 1.5:1, at least 1.8:1, at least 2:1, at least 3:1, at least 4:1, at least 5:1, at least 8:1, or even at least 10:1. Still, in another non-limiting embodiment, the secondary aspect ratio length:thickness of the body 351 can be not greater than 100:1, such as not greater than 50:1, not greater than 10:1, not greater than 8:1, not greater than 6:1, not greater than 5:1, not greater than 4:1, not greater than 3:1. It will be appreciated that the secondary aspect ratio the body 351 can be with a range including any of the minimum and maximum ratios and above.

Furthermore, the body 351 of the elongated abrasive particle 350 can include a tertiary aspect ratio of width:thickness that can be at least 1.1:1, such as at least 1.2:1, at least 1.5:1, at least 1.8:1, at least 2:1, at least 3:1, at least 4:1, at least 5:1, at least 8:1, or even at least 10:1. Still, in another non-limiting embodiment, the tertiary aspect ratio width:thickness of the body 351 can be not greater than 100:1, such as not greater than 50:1, not greater than 10:1, not greater than 8:1, not greater than 6:1, not greater than 5:1, not greater than 4:1, not greater than 3:1, or even not greater than 2:1. It will be appreciated the tertiary aspect ratio of width:thickness can be with a range including any of the minimum and maximum ratios of above.

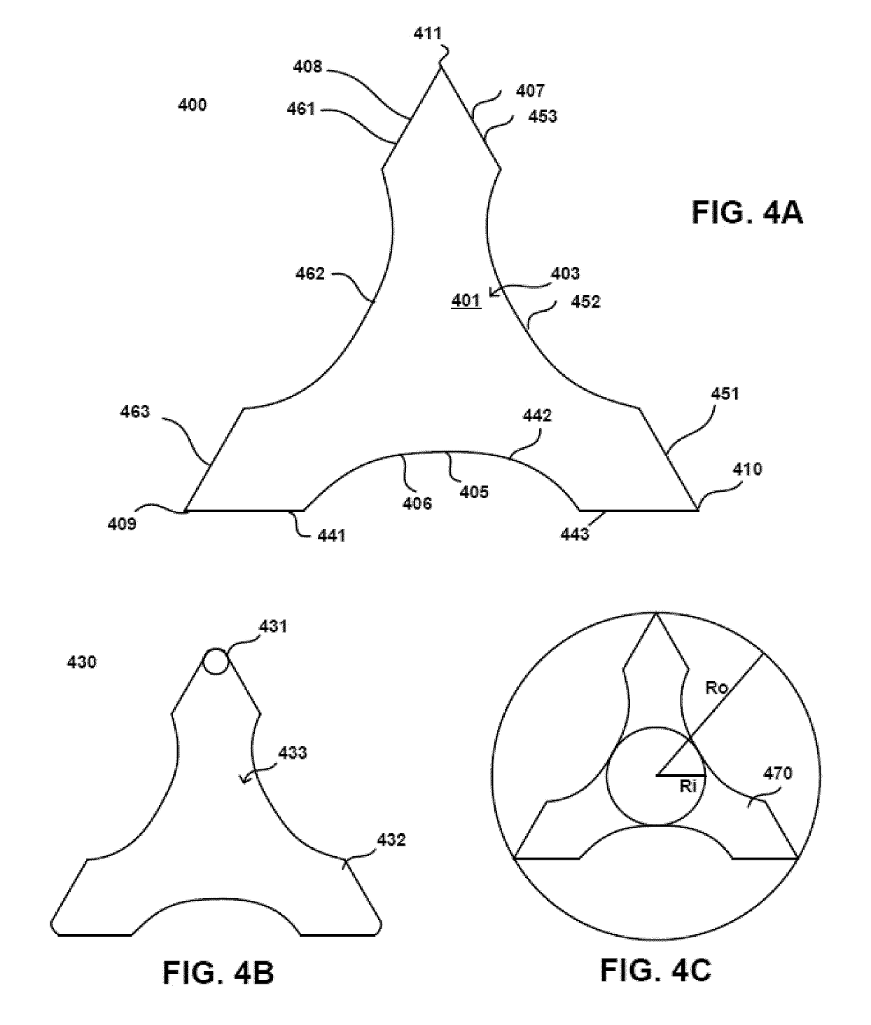

FIG. 4A includes a top view illustration of a shaped abrasive particle according to an embodiment. In particular, the shaped abrasive particle 400 can include a body 401 having the features of other shaped abrasive particles of embodiments herein, including an upper major surface 403 and a bottom major surface (not shown) opposite the upper major surface 403. The upper major surface 403 and the bottom major surface can be separated from each other by at least one side surface 405, which may include one or more discrete side surface portions, including for example, a first portion 406 of the side surface 405, a second portion 407 of the side surface 405, and a third portion 408 of the side surface 405. In particular, the first portion 406 of the side surface 405 can extend between a first corner 409 and a second corner 410. The second portion 407 of the side surface 405 can extend between the second corner 410 and a third corner 411. Notably, the second corner 410 can be an external corner joining two portions of the side surface 405. The second corner 410 and a third corner 411, which are also external corners, are adjacent to each other and have no other external corners disposed between them. Also, the third portion 408 of the side surface 405 can extend between the third corner 411 and the first corner 409, which are both external corners that are adjacent to each other and have no other external corners disposed between them.

As illustrated, the body 401 can have a perimeter defined by at least one linear section and at least one arcuate section. More particularly, the body 401 can include a first portion 406 including a first curved section 442 disposed between a first linear section 441 and a second linear section 443 and between the external corners 409 and 410. The second portion 407 is separated from the first portion 406 of the side surface 405 by the external corner 410. The second portion 407 of the side surface 405 can include a second curved section 452 joining a third linear section 451 and a fourth linear section 453. Furthermore, the body 401 can include a third portion 408 separated from the first portion 406 of the side surface 405 by the external corner 409 and separated from the second portion 407 by the external corner 411. The third portion 408 of the side surface 405 can include a third curved section 462 joining a fifth linear section 461 and a sixth linear section 463. In at least one embodiment, the body 401 may be a shape including a central region having three arms extending from the central region, each of the arms including tips including external corners (e.g., 409, 410, and 411) defined by a joint between two linear sections and at least one arcuate portion extending between two external corners. Moreover, as illustrated in FIG. 4A, the body 401 can have a two-dimensional shape having perimeter defined by at least three discrete linear portions (e.g., 441, 443, 451, 453, 461, and 463) and three discrete arcuate portions, wherein each of the three discrete arcuate portions (e.g., 441, 452, and 462) curved sections are separated from each other by at least one of discrete arcuate portions. The abrasive particle of FIG. 4A may be considered to have a partially concave triangular two-dimensional shape.

FIG. 4B includes a top view of a shaped abrasive particle 430 according to an embodiment. The tip sharpness of a shaped abrasive particle, which may be an average tip sharpness, may be measured by determining the radius of a best fit circle on an external corner 431 of the body 432. For example, turning to FIG. 4B, a top view of the upper major surface 433 of the body 432 is provided. At an external corner 431, a best fit circle is overlaid on the image of the body 432 of the shaped abrasive particle 430, and the radius of the best fit circle relative to the curvature of the external corner 431 defines the value of tip sharpness for the external corner 431. The measurement may be recreated for each external corner of the body 432 to determine the average individual tip sharpness for a single shaped abrasive particle 430. Moreover, the measurement may be recreated on a suitable sample size of shaped abrasive particles of a batch of shaped abrasive particles to derive the average batch tip sharpness. Any suitable computer program, such as ImageJ may be used in conjunction with an image (e.g., SEM image or light microscope image) of suitable magnification to accurately measure the best fit circle and the tip sharpness.

The shaped abrasive particles of the embodiments herein may have a particular tip sharpness that may facilitate suitable performance in the fixed abrasive articles of the embodiments herein. For example, the body of a shaped abrasive particle can have a tip sharpness of not greater than 80 microns, such as not greater than 70 microns, not greater than 60 microns, not greater than 50 microns, not greater than 40 microns, not greater than 30 microns, not greater than 20 microns, or even not greater than 10 microns. In yet another non-limiting embodiment, the tip sharpness can be at least 2 microns, such as at least 4 microns, at least 10 microns, at least 20 microns, at least 30 microns, at least 40 microns, at least 50 microns, at least 60 microns, or even at least 70 microns. It will be appreciated that the body can have a tip sharpness within a range between any of the minimum and maximum values noted above.

Another grain feature of shaped abrasive particles is the Shape Index. The Shape Index of a body of a shaped abrasive particle can be described as a value of an outer radius of a best-fit outer circle superimposed on the body, as viewed in two dimensions of a plane of length and width of the body (e.g., the upper major surface or the bottom major surface), compared to an inner radius of the largest best-fit inner circle that fits entirely within the body, as viewed in the same plane of length and width. For example, turning to FIG. 4C the shaped abrasive particle 470 is provided with two circles superimposed on the illustration to demonstrate the calculation of Shape Index. A first circle is superimposed on the body 470, which is a best-fit outer circle representing the smallest circle that can be used to fit the entire perimeter of the body 470 within its boundaries. The outer circle has a radius (Ro). For shapes such as that illustrated in FIG. 4C, the outer circle may intersect the perimeter of the body at each of the three external corners. However, it will be appreciated that for certain irregular or complex shapes, the body may not fit uniformly within the circle such that each of the corners intersect the circle at equal intervals, but a best-fit, outer circle still may be formed. Any suitable computer program, such as ImageJ may be used in conjunction with an image of suitable magnification (e.g., SEM image or light microscope image) to create the outer circle and measure the radius (Ro).

A second, inner circle can be superimposed on the body 470, as illustrated in FIG. 4C, which is a best fit circle representing the largest circle that can be placed entirely within the perimeter of the body 470 as viewed in the plane of the length and width of the body 470. The inner circle can have a radius (Ri). It will be appreciated that for certain irregular or complex shapes, the inner circle may not fit uniformly within the body such that the perimeter of the circle contacts portions of the body at equal intervals, such as shown for the shape of FIG. 4C. However, a best-fit, inner circle still may be formed. Any suitable computer program, such as ImageJ may be used in conjunction with an image of suitable magnification (e.g., SEM image or light microscope image) to create the inner circle and measure the radius (Ri).

The Shape Index can be calculated by dividing the outer radius by the inner radius (i.e., Shape Index=Ri/Ro). For example, the body 470 of the shaped abrasive particle has a Shape Index of approximately 0.35. Moreover, an equilateral triangle generally has a Shape Index of approximately 0.5, while other polygons, such as a hexagon or pentagon have Shape Index values greater than 0.5. In accordance with an embodiment, the shaped abrasive particles herein can have a Shape Index of at least 0.02, such as at least 0.05, at least 0.10, at least 0.15, at least 0.20, at least 0.25, at least 0.30, at least 0.35, at least 0.40, at least 0.45, at least about 0.5, at least about 0.55, at least 0.60, at least 0.65, at least 0.70, at least 0.75, at least 0.80, at least 0.85, at least 0.90, at least 0.95. Still, in another non-limiting embodiment, the shaped abrasive particle can have a Shape Index of not greater than 1, such as not greater than 0.98, not greater than 0.95, not greater than 0.90, not greater than 0.85, not greater than 0.80, not greater than 0.75, not greater than 0.70, not greater than 0.65, not greater than 0.60, not greater than 0.55, not greater than 0.50, not greater than 0.45, not greater than 0.40, not greater than 0.35, not greater than 0.30, not greater than 0.25, not greater than 0.20, not greater than 0.15, not greater than 0.10, not greater than 0.05, not greater than 0.02. It will be appreciated that the shaped abrasive particles can have a Shape Index within a range between any of the minimum and maximum values noted above.

According to one embodiment, at least a portion of the abrasive particles 110 (e.g., the first portion including the shaped abrasive particles 105) can be oriented in a predetermined orientation relative to each other and the substrate 101. While not completely understood, it is thought that one or a combination of dimensional features may facilitate improved positioning of the shaped abrasive particles 105. According to one embodiment, the shaped abrasive particles 105 can be oriented in a side orientation relative to the substrate 201, such as that shown in FIG. 1. In the side orientation, the side surface 115 of the shaped abrasive particles 105 can be closest to a surface of the substrate 101 (i.e., the backing) and the upper surface 113 and the bottom surface 114 defining the major surfaces of the thin shaped abrasive particles 105 can be spaced further away from the substrate 501 compared to the side surface 115. In particular instances, the bottom surface 114 can form an obtuse angle (B) relative to the surface of the substrate 111. Moreover, the upper surface 113 is spaced away and angled relative to the surface of the substrate 101, which in particular instances, may define a generally acute angle (A).

In particular instances, a majority of the shaped abrasive particles 105 of the total content of shaped abrasive particles 105 on the abrasive article 100 can have a predetermined side orientation. For certain other abrasive articles herein, at least about 55% of the plurality of shaped abrasive particles 105 on the abrasive article 100 can have a predetermined side orientation. Still, the percentage may be greater, such as at least about 60%, at least about 65%, at least about 70%, at least about 75%, at least about 77%, at least about 80%, at least about 81%, or even at least about 82%. And for one non-limiting embodiment, an abrasive article 100 may be formed using the shaped abrasive particles 105 herein, wherein not greater than about 99% of the total content of shaped abrasive particles have a predetermined side orientation. To determine the percentage of particles in a predetermined orientation, a 2D microfocus x-ray image of the abrasive article 500 is obtained using a CT scan machine run in the conditions of Table 1 below. The X-ray 2D imaging was conducted on RB214 with Quality Assurance software. A specimen mounting fixture utilizes a plastic frame with a 4″×4″ window and an Ø0.5″ solid metallic rod, the top part of which is half flattened with two screws to fix the frame. Prior to imaging, a specimen was clipped over one side of the frame where the screw heads were faced with the incidence direction of the X-rays. Then five regions within the 4″×4″ window area are selected for imaging at 120 kV/80 μA. Each 2D projection was recorded with the X-ray off-set/gain corrections and at a magnification of 15 times.

TABLE 1

| | | | Field of view | |
|---|---|---|---|---|
| Voltage | Current | | per image | |
| (kV) | (μA) | Magnification | (mm × mm) | Exposure time |
| 120 | 80 | 15X | 16.2 × 13.0 | 500 ms/2.0 fps |

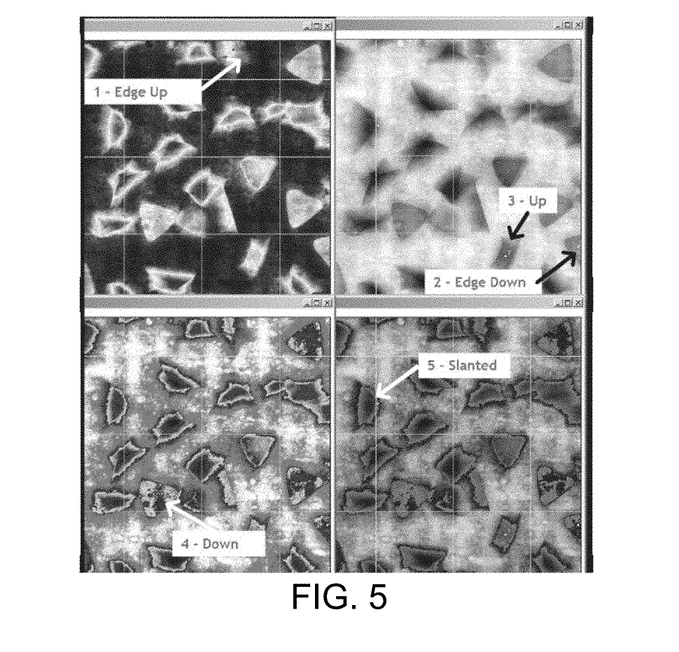

The image is then imported and analyzed using the ImageJ program, wherein different orientations are assigned values according to Table 2 below. FIG. 5 includes images representative of portions of a coated abrasive according to an embodiment and used to analyze the orientation of shaped abrasive particles on the backing.

TABLE 2

| Cell | |
|---|---|
| marker | |
| type | Comments |
| 1 | Grains on the perimeter of the image, partially |
| | exposed-standing up |
| 2 | Grains on the perimeter of the image, partially |
| | exposed-down |
| 3 | Grains on the image, completely exposed-standing vertical |
| 4 | Grains on the image, completely exposed-down |
| 5 | Grains on the image, completely exposed-standing slanted |
| | (between standing vertical and down) |

Three calculations are then performed as provided below in Table 3. After conducting the calculations, the percentage of grains in a particular orientation (e.g., side orientation) per square centimeter can be derived.

TABLE 3

| 5) Parameter | Protocol* |
|---|---|
| % grains up | ((0.5 × 1) + 3 + 5)/(1 + 2 + 3 + 4 + 5) |
| Total # of grains | (1 + 2 + 3 + 4 + 5) |
| # of grains up | (% grains up × Total # of grains) |

*These are all normalized with respect to the representative area of the image per cm².
+—A scale factor of 0.5 (See % of grains up in the numerator) was applied to account for the fact that they are not completely present in the image.

Furthermore, the coated abrasive article can utilize various contents of abrasive particles including nanocrystalline alumina. For example, the coated abrasive article can include a single layer of the abrasive particles in an open-coat configuration or a closed-coat configuration. For example, the abrasive particles can define an open-coat abrasive product having a coating density of abrasive particles of not greater than about 70 particles/cm². In other instances, the density of abrasive particle per square centimeter of the open-coat abrasive article may be not greater than about 65 particles/cm², such as not greater than about 60 particles/cm², not greater than about 55 particles/cm², or even not greater than about 50 particles/cm². Still, in one non-limiting embodiment, the density of the open-coat coated abrasive using the abrasive particles of the embodiments herein can be at least about 5 particles/cm² or even at least about 10 particles/cm². It will be appreciated that the density of abrasive particles per square centimeter of an open-coat coated abrasive article can be within a range between any of the above minimum and maximum values.

In an alternative embodiment, the coated abrasive article can have a closed-coat of abrasive particles having a coating density of abrasive particles of at least about 75 particles/cm², such as at least about 80 particles/cm², at least about 85 particles/cm², at least about 90 particles/cm², at least about 100 particles/cm². Still, in one non-limiting embodiment, the density of the closed-coat coated abrasive herein can be not greater than about 500 particles/cm². It will be appreciated that the density of abrasive particles per square centimeter of the closed-coat abrasive article can be within a range between any of the above minimum and maximum values.

In certain instances, the coated abrasive article can have an open-coat density, wherein not greater than about 50% of abrasive particles cover the exterior major abrasive surface of the coated abrasive article. In other embodiments, the percentage coating of the abrasive particles relative to the total area of the abrasive surface can be not greater than about 40%, such as not greater than about 30% or not greater than about 25% or even not greater than about 20%. Still, in one non-limiting embodiment, the percentage coating of the abrasive particles relative to the total area of the abrasive surface can be at least about 5%, such as at least about 10%, at least about 15%, at least about 20%, at least about 25%, at least about 30%, at least about 35%, or even at least about 40%. It will be appreciated that the percent coverage of abrasive particles for the total area of abrasive surface can be within a range between any of the above minimum and maximum values.

Certain coated abrasive articles of the embodiments herein can have a particular content of abrasive particles for a length (e.g., ream) of the substrate 101. For example, in one embodiment, the coated abrasive article may utilize a normalized weight of abrasive particles of at least about 20 lbs/ream, such as at least about 25 lbs/ream or even at least about 30 lbs/ream. Still, in one non-limiting embodiment, the coated abrasive article can include a normalized weight of abrasive particles of not greater than about 60 lbs/ream, such as not greater than about 50 lbs/ream or even not greater than about 45 lbs/ream. It will be appreciated that a coated abrasive article of the embodiments herein can utilize a normalized weight of abrasive particle within a range between any of the above minimum and maximum values.

In accordance with at least one embodiment, any of the abrasive particles of the embodiments herein can include nanocrystalline alumina, and the nanocrystalline alumina can have particular features, such as average crystallite (i.e., grain) size. For example, the average crystallite size of the nanocrystalline alumina particles may be not greater than 0.15 microns, such as not greater than 0.14 microns, not greater than 0.13 microns, or not greater than 0.12 microns, or even not greater than 0.11 microns. In another embodiment, the average crystallite size can be at least 0.01 microns, such as at least 0.02 microns, at least 0.05 microns, at least 0.06 microns, at least 0.07 microns, at least 0.08 microns, or at least about 0.09 microns. It will be appreciated that the average crystallite size can be within a range including any of the minimum to maximum values noted above. For example, the average crystallite size can be within a range of 0.01 microns to 0.15 microns, 0.05 microns to 0.14 microns, or 0.07 microns to 0.14 microns. In a particular embodiment, the crystallite size can be within a range of 0.08 microns to 0.14 microns.

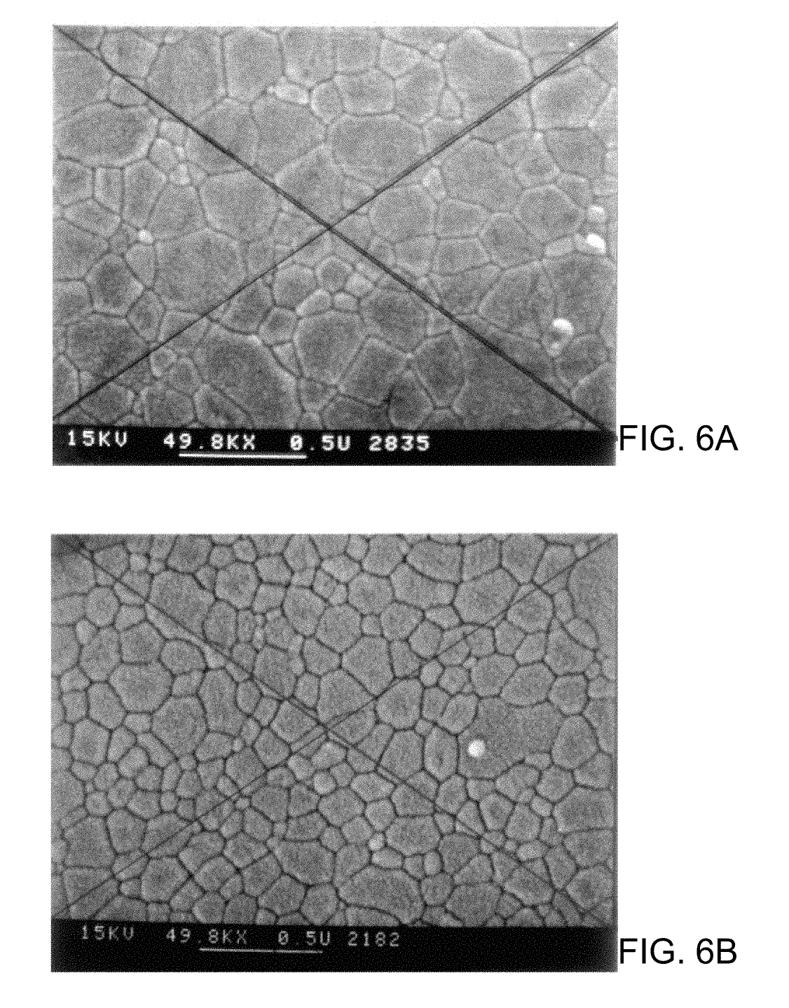

The average crystallite size can be measured based on the uncorrected intercept method using scanning electron microscope (SEM) photomicrographs. Samples of abrasive grains are prepared by making a bakelite mount in expoxy resin then polished with diamond polishing slurry using a Struers Tegramin 30 polishing unit. After polishing the epoxy is heated on a hot plate, the polished surface is then thermally etched for 5 minutes at 150° C. below sintering temperature. Individual grains (5-10 grits) are mounted on the SEM mount then gold coated for SEM preparation. SEM photomicrographs of three individual abrasive particles are taken at approximately 50,000× magnification, then the uncorrected crystallite size is calculated using the following steps: 1) draw diagonal lines from one corner to the opposite corner of the crystal structure view, excluding black data band at bottom of photo (see, for example, FIGS. 6A and 6B); 2) measure the length of the diagonal lines as L1 and L2 to the nearest 0.1 centimeters; 3) count the number of grain boundaries intersected by each of the diagonal lines, (i.e., grain boundary intersections I1 and I2) and record this number for each of the diagonal lines, 4) determine a calculated bar number by measuring the length (in centimeters) of the micron bar (i.e., “bar length”) at the bottom of each photomicrograph or view screen, and divide the bar length (in microns) by the bar length (in centimeters); 5) add the total centimeters of the diagonal lines drawn on photomicrograph (L1+L2) to obtain a sum of the diagonal lengths; 6) add the numbers of grain boundary intersections for both diagonal lines (I1+I2) to obtain a sum of the grain boundary intersections; 7) divide the sum of the diagonal lengths (L1+L2) in centimeters by the sum of grain boundary intersections (I1+I2) and multiply this number by the calculated bar number. This process is completed at least three different times for three different, randomly selected samples to obtain an average crystallite size.

As an example of calculating the bar number, assume the bar length as provided in a photo is 0.4 microns. Using a ruler the measured bar length in centimeters is 2 cm. The bar length of 0.4 microns is divided by 2 cm and equals 0.2 um/cm as the calculated bar number. The average crystalline size is calculated by dividing the sum of the diagonal lengths (L1+L2) in centimeters by the sum of grain boundary intersections (I1+I2) and multiply this number by the calculated bar number.

According to an embodiment, the nanocrystalline alumina can include at least 51 wt % alumina relative the total weight of the abrasive particles. For instance, the content of alumina within the nanocrystalline alumina can be at least about 60 wt %, at least 70 wt %, at least 80 wt %, at least about 85 wt %, or even higher, such as at least 90 wt %, at least 92 wt %, at least 93 wt %, or at least 94 wt %. In one non-limiting embodiment, the content of alumina may be not greater than 99.9 wt %, such as not be greater than 99 wt %, not greater than 98.5 wt %, not greater than 98 wt %, not greater than 97.5 wt %, not greater than 97 wt %, not greater than 96.5 wt %, or not greater than 96 wt %. It will be appreciated that the content of alumina can be within a range including any of the minimum to maximum percentages noted above. For example, the content can be within a range of 60 wt % to 99.9 wt %, within a range of 70 wt % to 99 wt %, within a range of 85 wt % to 98 wt %, or within a range of 90 wt % to 96.5 wt %. In a particular embodiment, the monocrystalline alumina can consist essentially of alumina, such as alpha alumina.

As described herein, the nanocrystalline alumina can have many particular features. These features can be similarly applied to the abrasive particles. For example, the abrasive particles can include a weight percent of alumina for the total weight of the abrasive particles that is similar to the content of the alumina relative to the total weight of the nanocrystalline alumina. For instance, the content of the alumina in the abrasive particles for the total weight of the abrasive particles can be at least at least 60 wt %, such as at least 70 wt %, at least 80 wt %, at least 85 wt %, at least 90 wt %, at least 92 wt %, at least 93 wt %, or at least 94 wt %. For another instance, the content of alumina in the abrasive particles may not be greater than 99.9 wt %, such as not be greater than 99 wt %, not greater than 98.5 wt %, not greater than 98 wt %, not greater than 97.5 wt %, not greater than 97 wt %, not greater than 96.5 wt %, or not greater than 96 wt %. It will be appreciated that the abrasive particles can include the alumina in the content within a range of minimum and maximum percentages noted above. For example, the content can be within a range of 60 wt % to 99.9 wt %, within a range of 70 wt % to 99 wt %, within a range of 85 wt % to 98 wt %, or within a range of 90 wt % to 96.5 wt %. In a particular embodiment, the abrasive particles can consist essentially of alumina, such as alpha alumina.

In accordance with an embodiment, the nanocrystalline alumina can include at least one additive. The additive can include a transition metal element, a rare-earth element, an alkali metal element, an alkaline earth metal element, silicon, or a combination thereof. In a further embodiment, the additive can be selected from the group consisting of a transition metal element, a rare-earth element, an alkali metal element, an alkaline earth metal element, silicon, and a combination thereof. It will be appreciated that the additive described in embodiments associated with the nanocrystalline alumina can be applied to the abrasive particles. In an embodiment, the abrasive particles can include one or more of the additives described herein.

In another embodiment, the additive can include a material including for example, magnesium, zirconium, calcium, silicon, iron, yttrium, lanthanum, cerium, or a combination thereof. In a further embodiment, the additive can include at least two materials selected from the group consisting of magnesium, zirconium, calcium, silicon, iron, yttrium, lanthanum, and cerium. It will be appreciated that the nanocrystalline alumina may consist essentially of alumina and one or more additives noted above. It will also be appreciated that the abrasive particles can consist essentially of alumina and one or more additives noted above.

In accordance with an embodiment, the total content of additives relative to the total weight of the nanocrystalline alumina particles may be not greater than 12 wt %, such as not be greater than 11 wt %, not greater than 10 wt %, not greater than 9.5 wt %, not greater than 9 wt %, not greater than 8.5 wt %, not greater than 8 wt %, not greater than 7.5 wt %, not greater than 7 wt %, not greater than 6.5 wt %, not greater than 6 wt %, not greater than 5.8 wt %, not greater than 5.5 wt %, or greater than 5.3 wt %, or not greater than 5 wt %. In another embodiment, the total content of additives can be at least 0.1 wt %, such as at least 0.3 wt %, at least 0.5 wt %, at least 0.7 wt %, at least 1 wt %, at least 1.3 wt %, at least 1.5 wt %, or at least 1.7 wt %, at least 2 wt %, at least 2.3 wt %, at least 2.5 wt %, at least 2.7 wt %, or even at least 3 wt %. It will be appreciated that the total content of additives within the nanocrystalline alumina can be within a range including any of the minimum to maximum percentages noted above. For example, the total content can be within a range 0.1 wt % to 12 wt %, such as within a range of 0.7 wt % to 9.5 wt %, or within a range of 1.3 wt % to 5.3 wt %. It will also be appreciated that the total content of the additives for the total weight of the abrasive particles can include the similar percentages or within a similar range of the embodiments herein.

In an embodiment, the additive can include magnesium oxide (MgO) in a content that can facilitate improving forming and/or performance of the abrasive article. The content of magnesium oxide relative to the total weight of the nanocrystalline alumina can be for example, at least 0.1 wt %, such as at least 0.3 wt %, at least 0.5 wt %, at least 0.7 wt %, or at least 0.8 wt %. For another instance, the content of magnesium oxide may be not greater than 5 wt %, such as not greater than 4.5 wt %, not greater than 4 wt %, not greater than 3.5 wt %, not greater than 3 wt %, or not greater than 2.8 wt %. It will be appreciated that the content of magnesium oxide can be within a range including any of the minimum to maximum percentages noted above. For example, the content can be within a range 0.1 wt % to 5 wt %, within a range of 0.3 wt % to 4.5 wt %, or within a range of 0.7 wt % to 2.8 wt %. In a particular embodiment, the nanocrystalline alumina may consist essentially of alumina and magnesium oxide within a range between any of the minimum and maximum values disclosed herein. It will also be appreciated that the content of magnesium oxide for the total weight of the abrasive articles can include any of the percentages or within any of the ranges described herein. In another particular embodiment, the abrasive particles may consist essentially of the nanocrystalline alumina and magnesium oxide within a range between any of the minimum and maximum values disclosed herein.

For another example, the additive can include zirconium oxide (ZrO₂), which may facilitate improved forming and/or performance of the abrasive article. The content of zirconium oxide for a total weight of the nanocrystalline alumina can be for example, at least 0.1 wt %, such as at least 0.3 wt %, at least 0.5 wt %, at least 0.7 wt %, at least 0.8 wt %, at least 1 wt %, at least 1.3 wt %, at least 1.5 wt %, at least 1.7 wt %, or at least 2 wt %. In another example, the content of zirconium oxide may be not greater than 8 wt %, not greater than 7 wt %, not greater than 6 wt %, not greater than 5.8 wt %, not greater than 5.5 wt %, or not greater than 5.2 wt %. It will be appreciated that the content of zirconium oxide can be within a range including any of the minimum to maximum percentages noted above. For example, the content can be within a range 0.1 wt % to 8 wt %, within a range of 0.3 wt % to 7 wt %, or within a range of 0.5 wt % to 5.8 wt %. In a particular embodiment, the nanocrystalline alumina may consist essentially of alumina and zirconium oxide within the range of embodiments herein. It will be also appreciated that the content of zirconium oxide for the total weight of the abrasive particles can include any of the percentages or within any of the ranges noted herein. In another particular embodiment, the abrasive particles may consist essentially of nanocrystalline alumina and ZrO2 within a range between any of the minimum and maximum percentages noted above.

In accordance with an embodiment, the additive can include magnesium oxide (MgO) and zirconium oxide (ZrO₂) in a particular additive ratio that can facilitate improved forming and/or performance of the abrasive article. The additive ratio (MgO/ZrO₂) can be a weight percent ratio of magnesium oxide to zirconium oxide, wherein MgO is the weight percent of MgO in the nanocrystalline alumina and ZrO₂ is the weight percent of ZrO₂ in the nanocrystalline alumina. For example, the ratio can be not greater than 1.5, such as not greater than 1.4, not greater than 1.3, not greater than 1.2, not greater than 1.1, not greater than 1, not greater than 0.95, not greater than 0.9, not greater than 0.85, not greater than 0.8, not greater than 0.75, not greater than 0.7, not greater than 0.65, not greater than 0.6, or not greater than 0.55. In another instance, the additive ratio (MgO/ZrO₂) can be at least about 0.01, at least 0.05, at least 0.1, at least 0.2, at least 0.3, at least 0.4, or at least 0.5. It will be appreciated that the additive ratio (MgO/ZrO₂) can be within a range including any of the minimum to maximum ratios noted above. For example, the additive ratio (MgO/ZrO₂) can be within a range 0.01 to 1.5, within a range of 0.1 to 1.1, or within a range of 0.3 to 0.95. In a particular embodiment, the nanocrystalline alumina can consist essentially of alumina, and magnesium oxide and zirconium oxide in the additive ratio within the range including any of the minimum to maximum ratios described herein. It will also be appreciated that the abrasive particles can include magnesium oxide (MgO) and zirconium oxide (ZrO₂) in the weight percent ratio disclosed herein. In a particular embodiment, the abrasive particles may consist essentially of nanocrystalline alumina, and magnesium oxide and zirconium oxide in the additive ratio within the range including any of the minimum to maximum ratios described herein.

According to one embodiment, the additive can include calcium oxide (CaO). The nanocrystalline alumina can include a certain content of calcium oxide relative to the total weight of the nanocrystalline alumina that can facilitate improved forming and/or performance of the abrasive article. For example, the content of calcium oxide can be at least 0.01 wt %, such as at least 0.05 wt %, at least about 0.07 wt %, at least 0.1 wt %, at least 0.15 wt %, at least 0.2 wt %, or at least 0.25 wt %. In another instance, the content may be not greater than 5 wt %, such as not greater than 4 wt %, not greater than 3 wt %, not greater than 2 wt %, not greater than 1 wt %, not greater than 0.7 wt %, or not greater than 0.5 wt %. It will be appreciated that the content of calcium oxide can be within a range including any of the minimum to maximum ratios noted above. For example, the content can be within a range 0.01 wt % to 5 wt %, within a range of 0.07 wt % to 3 wt %, or within a range of 0.15 wt % to 0.7 wt %. In a particular embodiment, the nanocrystalline alumina can consist essentially of alumina, and calcium oxide in the content within the range including any of the minimum to maximum percentages described herein. It will also be appreciated that the content of calcium oxide for the total weight of the abrasive particles can include any of the percentages or within any of the ranges noted herein. In another particular embodiment, the abrasive particles may consist essentially of nanocrystalline alumina and ZrO2 within a range between any of the minimum and maximum percentages noted above.

According to another embodiment, the additive can include magnesium oxide (MgO) and calcium oxide (CaO). The nanocrystalline alumina can have an additive ratio (CaO/MgO), wherein MgO is the weight percent of MgO in the nanocrystalline alumina and CaO is the weight percent of CaO in the nanocrystalline alumina. The additive ratio may facilitate improved forming and/or performance. For an instance, the additive ratio may be, not greater than 1, such as not greater than 0.95, not greater than 0.9, not greater than 0.85, not greater than 0.8, not greater than 0.75, not greater than 0.7, not greater than 0.65, not greater than 0.6, not greater than 0.55, not greater than 0.5, not greater than 0.45, or not greater than 0.4. For another example, the ratio can be at least 0.01, such as at least 0.05, at least 0.1, at least 0.15, at least 0.2, or at least 0.25. It will be appreciated that the additive ratio (CaO/MgO) can be within a range including any of the minimum and maximum ratios noted above. For example, the additive ratio can be within a range 0.01 to 1, within a range of 0.05 to 0.9, or within a range of 0.1 to 0.75. In a particular embodiment, the nanocrystalline alumina can consist essentially of alumina, and magnesium oxide and calcium oxide in the additive ratio within the range including any of the minimum and maximum ratios described herein. It will also be appreciated that the additive ratio of calcium oxide to magnesium oxide can include any of the ratios or within any of the ranges described herein. In another particular embodiment, the abrasive particles may consist essentially of nanocrystalline alumina, and calcium oxide and magnesium oxide in the additive ratio within a range between any of the minimum and maximum ratios noted above.

According to one embodiment, the nanocrystalline alumina can include a rare earth oxide. The examples of rare earth oxide can yttrium oxide, cerium oxide, praseodymium oxide, samarium oxide, ytterbium oxide, neodymium oxide, lanthanum oxide, gadolinium oxide, dysprosium oxide, erbium oxide, precursors thereof, or the like. In a particular embodiment, the rare earth oxide can be selected from the group consisting of yttrium oxide, cerium oxide, praseodymium oxide, samarium oxide, ytterbium oxide, neodymium oxide, lanthanum oxide, gadolinium oxide, dysprosium oxide, erbium oxide, precursors thereof, and combinations thereof. In another embodiment, the nanocystalline alumina can be essentially free of a rare earth oxide and iron. In a further embodiment the abrasives particles can include a phase containing a rare earth, a divalent cation and alumina which may be in the form of a magnetoplumbite structure. An example of a magnetoplumbite structure is MgLaAl₁₁O₁₉.

In accordance with an embodiment, the nanocrystalline alumina can include a rare earth alumina crystallite. In another embodiment, the nanocrystalline alumina can include a rare earth aluminate phase. Still, according to another embodiment, the nanocrystalline alumina can include a spinel material. It will be appreciated that the abrasive particles can include a rare earth alumina crystallite, a rare earth aluminate phase, or a spinel material.

According to one embodiment, the nanocrystalline alumina can include nanocrystalline particles (e.g., grains or domains), which may be suitable for improving the formation and/or performance of an abrasive article. In certain embodiments, each nanocrystalline particle can include at least 50 vol % crystalline material, such as single crystalline material or polycrystalline material, for the total volume of each nanocrystalline particle. For example, each particle can include at least 75 vol % crystalline material, at least 85 vol % crystalline material, at least 90 vol % crystalline material, or at least 95 vol % crystalline material. In a particular embodiment, the nanocrystalline particles can consist essentially of crystalline material. It will be appreciated that the above described features of the nanocrystalline alumina can be applied to the abrasive particles. For example, each abrasive particle can include at least 50 vol % of crystalline material, such as single crystalline material or polycrystalline material, for the total volume of each abrasive particle. Moreover, it will be appreciated that the abrasive particles may consist essentially of a crystalline material including alpha alumina and one or more additives as described in the embodiments herein. More particularly, in at least one embodiment, the abrasive particles may consist essentially of a crystalline material consisting of alpha alumina and one or more additives as described in the embodiments herein.

In an embodiment, the nanocrystalline alumina can have certain physical properties including Vickers hardness and density. For example, Vickers hardness of the nanocrystalline alumina can be at least 18 GPa, at least 18.5 GPa, at least 19 GPa, or even at least 19.5 GPa. In another instance, Vickers hardness of the nanocrystalline alumina may not be greater than 26.5 GPa, such as not greater than 26 GPa, not greater than 25.5 GPa, not greater than 25 GPa, or even not greater than 24.5 GPa. It will be appreciated that the nanocrystalline alumina can have Vickers hardness within a range including any of the minimum to maximum values noted above. For example, Vickers hardness can be within a range of 18 GPa to 24.5 or within a range of 19 GPa to 24 GPa. In another embodiment, the physical properties of the nanocrystalline alumina can be similarly applied to the abrasive particles. For example the abrasive particles can have Vickers hardness noted above.

It will be appreciated that Vickers hardness is measured based on a diamond indentation method (well known in the art) of a polished surface of the abrasive grain. Samples of abrasive grains are prepared by making a bakelite mount in epoxy resin then polished with diamond polishing slurry using a Struers Tegramin 30 polishing unit. Using an Instron-Tukon 2100 Microhardness tester with a 500 gm load and a 50× objective lens, measure 5 diamond indents on five different abrasive particles. Measurement is in Vickers units and is converted to GPa by dividing the Vickers units by 100. Average and range of hardness are reported for a suitable sample size to make a statistically relevant calculation.

In an embodiment, the nanocrystalline alumina can have relative friability, which is breakdown of the nanocrystalline alumina relative to breakdown of the microcrystalline alumina having the same grit size, both of which breakdown is measured in the same manner as disclosed in more details below. The relative friability of the nanocrystalline alumina can be expressed in form of percentage, and that of the corresponding microcrystalline alumina is regarded as standard and set to be 100%. In an embodiment, the relative friability of the nanocrystalline alumina can be greater than 100%. For instance, the relative friability of the nanocrystalline alumina can be at least 102%, such as at least 105%, at least 108%, at least 110%, at least 112%, at least 115%, at least 120%, at least 125%, or at least 130%. In another instance, the relative friability of the nanocrystalline alumina may be not greater than 160%.

The relative friability is generally measured by milling a sample of the particles using tungsten carbide balls having an average diameter of ¾ inches for a given period of time, sieving the material resulting from the ball milling, and measuring the percent breakdown of the sample against that of a standard sample, which in the present embodiments, was a microcrystalline alumina sample having the same grit size.

Prior to ball milling, approximately 300 grams to 350 grams grains of a standard sample (e.g., microcrystalline alumina available as Cerpass® HTB from Saint-Gobain Corporation) are sieved utilizing a set of screens placed on a Ro-Tap® sieve shaker (model RX-29) manufactured by WS Tyler Inc. The grit sizes of the screens are selected in accordance with ANSI Table 3, such that a determinate number and types of sieves are utilized above and below the target particle size. For example, for a target particle size of grit 80, the process utilizes the following US Standard Sieve sizes, 1) 60, 2) 70; 3) 80; 4) 100; and 5) 120. The screens are stacked so that the grit sizes of the screens increase from top to bottom, and a pan is placed beneath the bottom screen to collect the grains that fall through all of the screens. The Ro-Tap® sieve shaker is run for 10 minutes at a rate of 287±10 oscillations per minute with the number of taps count being 150±10, and only the particles on the screen having the target grit size (referred to as target screen hereinafter) are collected as the target particle size sample. The same process is repeated to collect target particle size samples for the other test samples of material.

After sieving, a portion of each of the target particle size samples is subject to milling.

An empty and clean mill container is placed on a roll mill. The speed of the roller is set to 305 rpms, and the speed of the mill container is set to 95 rpms. About 3500 grams of flattened spherical tungsten carbide balls having an average diameter of ¾ inches are placed in the container. 100 grams of the target particle size sample from the standard material sample are placed in the mill container with the balls. The container is closed and placed in the ball mill and run for a duration of 1 minute to 10 minutes. Ball milling is stopped, and the balls and the grains are sieved using the Ro-Tap® sieve shaker and the same screens as used in producing the target particle size sample. The rotary tapper is run for 5 minutes using the same conditions noted above to obtain the target particles size sample, and all the particles that fall through the target screen are collected and weighed. The percent breakdown of the standard sample is the mass of the grains that passed through the target screen divided by the original mass of the target particle size sample (i.e., 100 grams). If the percent breakdown is within the range of 48% to 52%, a second 100 grams of the target particle size sample is tested using exactly the same conditions as used for the first sample to determine the reproducibility. If the second sample provides a percent breakdown within 48%-52%, the values are recorded. If the second sample does not provide a percent breakdown within 48% to 52%, the time of milling is adjusted, or another sample is obtained and the time of milling is adjusted until the percent breakdown falls within the range of 48%-52%. The test is repeated until two consecutive samples provide a percent breakdown within the range of 48%-52%, and these results are recorded.

The percent breakdown of a representative sample material (e.g., nanocrystalline alumina particles) is measured in the same manner as measuring the standard sample having the breakdown of 48% to 52%. The relative friability of the nanocrystalline alumina sample is the breakdown of the nanocrystalline sample relative to that of the standard microcrystalline sample.

In another instance, the nanocrystalline alumina can have a density of at least 3.85 g/cc, such as at least 3.9 g/cc or at least 3.94 g/cc. In another embodiment, the density of the nanocrystalline alumina may not be greater than 4.12 g/cc, such as not greater than 4.08 g/cc, not greater than 4.02 g/cc, or even not greater than 4.01 g/cc. It will be appreciated that the nanocrystalline alumina can have a density within a range including any of the minimum to maximum values described herein. For example, the density can be within a range of 3.85 g/cc to 4.12 g/cc or 3.94 g/cc to 4.01 g/cc. It will also be appreciated that the density of the abrasive particles can include any of the values or within any of the ranges descried herein.

According to an embodiment, the abrasive particles can include at least one type of abrasive particle. For example, the abrasive particles can include a blend including a first type of abrasive particle and a second type of abrasive particle. The first type of abrasive particle can include an abrasive particle comprising nanocrystalline alumina according to any of the embodiments herein. The second type of abrasive particle can include at least one material selected from the group consisting of oxides, carbides, nitrides, borides, oxycarbides, oxynitrides, superabrasives, carbon-based materials, agglomerates, aggregates, shaped abrasive particles, diluent particles, and a combination thereof. In a particular embodiment, the abrasive particles can consist essentially of nanocrystalline alumina.

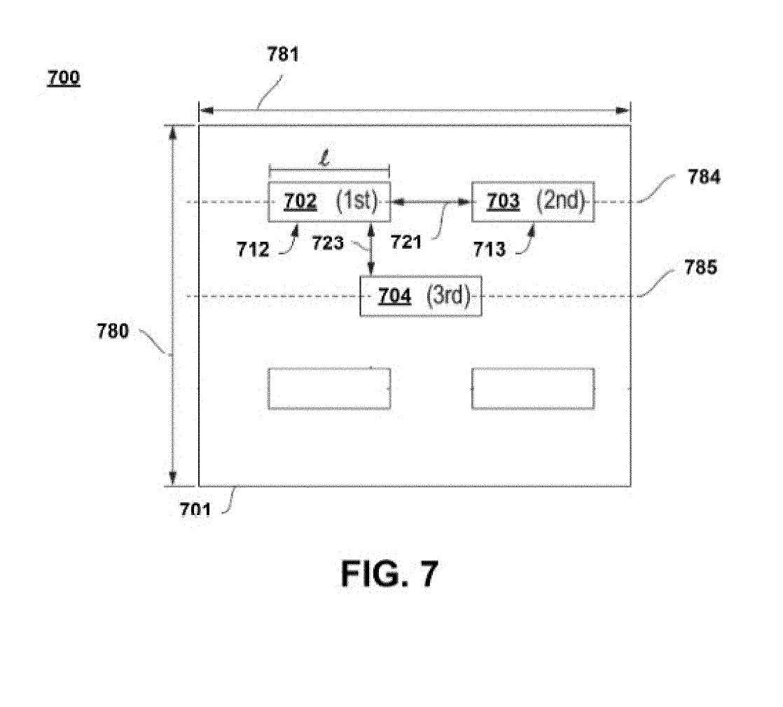

FIG. 7 includes a top view illustration of a portion of a coated abrasive article including abrasive particles having predetermined positions and controlled orientation according to an embodiment. Moreover, as part of the predetermined position, the abrasive particles may be arranged in a controlled distribution on the substrate. A controlled distribution can be defined by a combination of predetermined positions of abrasive particles on a backing that are purposefully selected. A controlled distribution can include a pattern, such that the predetermined positions can define a two-dimensional array. An array can include have short range order defined by a unit of abrasive particles. An array may also be a pattern, having long range order including regular and repetitive units linked together, such that the arrangement may be symmetrical and/or predictable. An array may have an order that can be predicted by a mathematical formula. It will be appreciated that two-dimensional arrays can be formed in the shape of polygons, ellipsis, ornamental indicia, product indicia, or other designs. A controlled distribution can also include a non-shadowing arrangement. A non-shadowing arrangement may include a controlled, non-uniform distribution, a controlled uniform distribution, and a combination thereof. In particular instances, a non-shadowing arrangement may include a radial pattern, a spiral pattern, a phyllotactic pattern, an asymmetric pattern, a self-avoiding random distribution, a self-avoiding random distribution and a combination thereof.

As illustrated, the coated abrasive article 700 includes a backing 701 that can be defined by a longitudinal axis 780 that extends along and defines a length of the backing 701 and a lateral axis 781 that extends along and defines a width of the backing 701. In accordance with an embodiment, an abrasive particle 702 (e.g., a shaped abrasive particle) can be located in a first, predetermined position 712 defined by a particular first lateral position relative to the lateral axis of 781 of the backing 701 and a first longitudinal position relative to the longitudinal axis 780 of the backing 701. Moreover, the abrasive particle 702 can have a controlled orientation including at least one of a predetermined rotational orientation, a predetermined lateral orientation, and a predetermined longitudinal orientation. Notably, wherein the abrasive particle 702 is a shaped abrasive particle, the major surfaces can be oriented relative to the longitudinal and lateral axes 780 and 781 to define a predetermined rotational orientation, a predetermined lateral orientation, and a predetermined longitudinal orientation.

Furthermore, an abrasive particle 703 (e.g., a shaped abrasive particle) may have a second, predetermined position 713 defined by a second lateral position relative to the lateral axis 781 of the backing 701, and a first longitudinal position relative to the longitudinal axis 780 of the backing 701 that is substantially the same as the first longitudinal position of the shaped abrasive particle 702. Notably, the abrasive particles 702 and 703 may be spaced apart from each other by a lateral space 721, defined as a smallest distance between the two adjacent abrasive particles 702 and 703 as measured along a lateral plane 784 parallel to the lateral axis 781 of the backing 701. In accordance with an embodiment, the lateral space 721 can be greater than zero, such that some distance exists between the abrasive particles 702 and 703. However, while not illustrated, it will be appreciated that the lateral space 721 can be zero, allowing for contact and even overlap between portions of adjacent abrasive particle.

As further illustrated, the coated abrasive article 700 can include an abrasive particle 704 located at a third, predetermined position 714 defined by a second longitudinal position relative to the longitudinal axis 780 of the backing 701 and also defined by a third lateral position relative to a lateral plane 785 parallel to the lateral axis 781 of the backing 701 and spaced apart from the lateral axis 784. Further, as illustrated, a longitudinal space 723 may exist between the abrasive particles 702 and 704, which can be defined as a smallest distance between the two adjacent abrasive particles 702 and 704 as measured in a direction parallel to the longitudinal axis 780. In accordance with an embodiment, the longitudinal space 723 can be greater than zero. Still, while not illustrated, it will be appreciated that the longitudinal space 723 can be zero, such that the adjacent shaped abrasive particles are touching, or even overlapping each other. While reference has been made herein to a coated abrasive article 700 having a longitudinal axis 780 and a lateral axis 781, it will be appreciated that such predetermined positions and controlled orientation can be utilized for coated abrasive articles having a circular geometry and the predetermined position and controlled orientation is equally relevant to reference axes and planes in a circular geometry (e.g., radial axis, circumferential position).

Many different aspects and embodiments are possible. Some of those aspects and embodiments are described herein. After reading this specification, skilled artisans will appreciate that those aspects and embodiments are only illustrative and do not limit the scope of the present invention.

### EMBODIMENTS

### Embodiment 1

A coated abrasive article comprising:
a body including:
a substrate;
a bond material overlying the substrate; and
a layer of abrasive particles contained within the bond material, the abrasive particles comprising nanocrystalline alumina.

### Embodiment 2

A method of forming a coated abrasive article comprising: applying a layer of abrasive particles to a substrate comprising a bond material, wherein the abrasive particles comprise nanocrystalline alumina.

### Embodiment 3

The coated abrasive article or method of embodiment 1 or 2, wherein the coated abrasive article comprises an open coat of the plurality of shaped abrasive particles overlying the substrate, wherein the open coat comprises a coating density of not greater than about 70 particles/cm2, not greater than about 65 particles/cm2, not greater than about 60 particles/cm2, not greater than about 55 particles/cm2, not greater than about 50 particles/cm2, at least about 5 particles/cm2, at least about 10 particles/cm2.

### Embodiment 4

The coated abrasive article or method of embodiment 1 or 2, wherein the coated abrasive article comprises a closed coat of abrasive particles overlying the substrate, wherein the closed coat comprises a coating density of at least about 75 particles/cm2, at least about 80 particles/cm2, at least about 85 particles/cm2, at least about 90 particles/cm2, at least about 100 particles/cm2.

### Embodiment 5

The coated abrasive article or method of embodiment 1 or 2, wherein the substrate comprises a woven material, wherein the substrate comprises a non-woven material, wherein the substrate comprises an organic material, wherein the substrate comprises a polymer, wherein the substrate comprises a material selected from the group consisting of cloth, paper, film, fabric, fleeced fabric, vulcanized fiber, woven material, non-woven material, webbing, polymer, resin, phenolic resin, phenolic-latex resin, epoxy resin, polyester resin, urea formaldehyde resin, polyester, polyurethane, polypropylene, polyimides, and a combination thereof.

### Embodiment 6

The coated abrasive article or method of embodiment 1 or 2, wherein the substrate comprises an additive chosen from the group consisting of catalysts, coupling agents, currants, anti-static agents, suspending agents, anti-loading agents, lubricants, wetting agents, dyes, fillers, viscosity modifiers, dispersants, defoamers, and grinding agents.

### Embodiment 7

The coated abrasive article or method of embodiment 1 or 2, wherein the bond material includes at least one adhesive layer overlying the substrate, wherein the adhesive layer comprises a make coat, wherein the make coat overlies the substrate, wherein the make coat is bonded directly to a portion of the substrate, wherein the make coat comprises an organic material, wherein the make coat comprises a polymeric material, wherein the make coat comprises a material selected from the group consisting of polyesters, epoxy resins, polyurethanes, polyamides, polyacrylates, polymethacrylates, poly vinyl chlorides, polyethylene, polysiloxane, silicones, cellulose acetates, nitrocellulose, natural rubber, starch, shellac, and a combination thereof.

### Embodiment 8

The coated abrasive article or method of embodiment 1 or 2, wherein the bond material comprises at least one adhesive layer overlying the substrate, wherein the adhesive layer comprises a size coat, wherein the size coat overlies a portion of the abrasive particles, wherein the size coat overlies a make coat, wherein the size coat is bonded directly to a portion of the abrasive particles, wherein the size coat comprises an organic material, wherein the size coat comprises a polymeric material, wherein the size coat comprises a material selected from the group consisting of polyesters, epoxy resins, polyurethanes, polyamides, polyacrylates, polymethacrylates, polyvinyl chlorides, polyethylene, polysiloxane, silicones, cellulose acetates, nitrocellulose, natural rubber, starch, shellac, and a combination thereof.

### Embodiment 9

The coated abrasive article or method of embodiment 1 or 2, wherein the abrasive particles comprise nanocrystalline alumina having an average crystallite size of not greater than about 0.15 microns or not greater than about 0.14 microns or not greater than about 0.13 microns or not greater than 0.12 or not greater than 0.11 or not greater than 0.1.

### Embodiment 10

The coated abrasive article or method of embodiment 1 or 2, wherein the abrasive particles comprise nanocrystalline alumina having an average crystallite size of at least about 0.01 microns or at least about 0.02 microns or at least about 0.05 microns or at least about 0.06 microns or at least about 0.07 microns or at least about 0.08 microns or at least about 0.09 microns.

### Embodiment 11

The coated abrasive article or method of embodiment 1 or 2, wherein the nanocrystalline alumina comprises at least about 51 wt % alumina for the total weight of the particles or at least about 60 wt % or at least about 70 wt % or at least about 80 wt % or at least about 85 wt % or at least about 90 wt % or at least about 92 wt % or at least about 93 wt % or at least about 94 wt %.

### Embodiment 12

The coated abrasive article or method of embodiment 1 or 2, wherein the nanocrystalline alumina comprises not greater than about 99.9 wt % alumina for the total weight of the particles or not greater than about 99 wt % or not greater than about 98.5 wt % or not greater than about 98 wt % or not greater than about 97.5 wt % or not greater than about 97 wt % or not greater than about 96.5 wt % or not greater than about 96 wt %.

### Embodiment 13

The coated abrasive article or method of embodiment 1 or 2, wherein the nanocrystalline alumina comprises at least one additive selected from the group consisting of a transition metal element, a rare-earth element, an alkali metal element, an alkaline earth metal element, silicon, and a combination thereof.

### Embodiment 14

The coated abrasive article or method of embodiment 13, wherein the additive comprises a material selected from the group consisting of magnesium, zirconium, calcium, silicon, iron, yttrium, lanthanum, cerium, and a combination thereof.

### Embodiment 15

The coated abrasive article or method of embodiment 13, wherein the additive includes at least two materials selected from the group consisting of magnesium, zirconium, calcium, silicon, iron, yttrium, lanthanum, and cerium.

### Embodiment 16

The coated abrasive article or method of embodiment 13, wherein the nanocrystalline alumina comprises a total content of additive of not greater than about 12 wt % for a total weight of the nanocrystalline alumina particles or not greater than about 11 wt % or not greater than about 10 wt % or not greater than about 9.5 wt % or not greater than about 9 wt % or not greater than about 8.5 wt % or not greater than about 8 wt % or not greater than about 7.5 wt % or not greater than about 7 wt % or not greater than about 6.5 wt % or not greater than about 6 wt % or not greater than about 5.8 wt % or not greater than about 5.5 wt % or not greater than about 5.3 wt % or not greater than about 5 wt %.

### Embodiment 17

The coated abrasive article or method of embodiment 13, wherein the nanocrystalline alumina comprises a total content of additive of at least about 0.1 wt % for a total weight of the nanocrystalline alumina particles or at least about 0.3 wt % or at least about 0.5 wt % or at least about 0.7 wt % or at least about 1 wt % or at least about 1.3 wt % or at least about 1.5 wt % or at least about 1.7 wt % or at least about 2 wt % or at least about 2.3 wt % or at least about 2.5 wt % or at least about 2.7 wt % or at least about 3 wt %.

### Embodiment 18

The coated abrasive article or method of embodiment 13, wherein the additive includes magnesium oxide (MgO).

### Embodiment 19

The coated abrasive article or method of embodiment 18, wherein the nanocrystalline alumina comprises at least about 0.1 wt % MgO for a total weight of the nanocrystalline alumina or at least about 0.3 wt % or at least about 0.5 wt % or at least about 0.7 wt % or at least about 0.8 wt %.

### Embodiment 20

The coated abrasive article or method of embodiment 18, wherein the nanocrystalline alumina comprises not greater than about 5 wt % MgO for a total weight of the nanocrystalline alumina or not greater than about 4.5 wt % or not greater than about 4 wt % or not greater than about 3.5 wt % or not greater than about 3 wt % or not greater than about 2.8 wt %.

### Embodiment 21

The coated abrasive article or method of embodiment 13, wherein the additive includes zirconium oxide (ZrO2).

### Embodiment 22

The coated abrasive article or method of embodiment 21, wherein the nanocrystalline alumina comprises at least about 0.1 wt % ZrO2 for a total weight of the nanocrystalline alumina or at least about 0.3 wt % or at least about 0.5 wt % or at least about 0.7 wt % or at least about 0.8 wt % or at least about 1 wt % or at least about 1.3 wt % or at least about 1.5 wt % or at least about 1.7 wt % or at least about 2 wt %.

### Embodiment 23

The coated abrasive article or method of embodiment 21, wherein the nanocrystalline alumina comprises not greater than about 8 wt % ZrO2 for a total weight of the nanocrystalline alumina or not greater than about 7 wt % or not greater than about 6 wt % or not greater than about 5.8 wt % or not greater than about 5.5 wt % or not greater than about 5.2 wt %.

### Embodiment 24

The coated abrasive article or method of embodiment 13, wherein the additive includes magnesium oxide (MgO) and zirconium oxide (ZrO2).

### Embodiment 25

The coated abrasive article or method of embodiment 24, wherein the nanocrystalline alumina comprises an additive ratio (MgO/ZrO2) of not greater than 1.5, wherein MgO is the weight percent of MgO in the nanocrystalline alumina and ZrO2 is the weight percent of ZrO2 in the nanocrystalline alumina, wherein the additive ratio is (MgO/ZrO2) is not greater than about 1.4 or not greater than about 1.3 or not greater than about 1.2 or not greater than about 1.1 or not greater than about 1 or not greater than about 0.95 or not greater than about 0.9 or not greater than about 0.85 or not greater than about 0.8 or not greater than about 0.75 or not greater than about 0.7 or not greater than about 0.65 not greater than about 0.6 or not greater than about 0.55.

### Embodiment 26

The coated abrasive article or method of embodiment 24, wherein the nanocrystalline alumina comprises an additive ratio (MgO/ZrO2) of at least about 0.01, wherein MgO is the weight percent of MgO in the nanocrystalline alumina and ZrO2 is the weight percent of ZrO2 in the nanocrystalline alumina, wherein the additive ratio is (MgO/ZrO2) is at least about 0.05 or at least about 0.1 or at least about 0.2 or at least about 0.3 or at least about 0.4 or at least about 0.5.

### Embodiment 27

The coated abrasive article or method of embodiment 13, wherein the additive includes calcium oxide (CaO).

### Embodiment 28

The coated abrasive article or method of embodiment 27, wherein the nanocrystalline alumina comprises at least about 0.01 wt % CaO for a total weight of the nanocrystalline alumina or at least about 0.05 wt % or at least about 0.07 wt % or at least about 0.1 wt % or at least about 0.15 wt % or at least about 0.2 wt % or at least about 0.25 wt %.

### Embodiment 29

The coated abrasive article or method of embodiment 27, wherein the nanocrystalline alumina comprises not greater than about 5 wt % CaO for a total weight of the nanocrystalline alumina or not greater than about 4 wt % or not greater than about 3 wt % or not greater than about 2 wt % or not greater than about 1 wt % or not greater than about 0.7 wt % or not greater than about 0.5 wt %.

### Embodiment 30

The coated abrasive article or method of embodiment 13, wherein the additive includes magnesium oxide (MgO) and calcium oxide (CaO).

### Embodiment 31

The coated abrasive article or method of embodiment 30, wherein the nanocrystalline alumina comprises an additive ratio (CaO/MgO) of not greater than 1, wherein MgO is the weight percent of MgO in the nanocrystalline alumina and CaO is the weight percent of CaO in the nanocrystalline alumina, wherein the additive ratio is (CaO/MgO) is not greater than about 0.95 or not greater than about 0.9 or not greater than about 0.85 or not greater than about 0.8 or not greater than about 0.75 or not greater than about 0.7 or not greater than about 0.65 not greater than about 0.6 or not greater than about 0.55 or not greater than about 0.5 or not greater than about 0.45 not greater than about 0.4.

### Embodiment 32

The coated abrasive article or method of embodiment 30, wherein the nanocrystalline alumina comprises an additive ratio (CaO/MgO) of at least about 0.01, wherein MgO is the weight percent of MgO in the nanocrystalline alumina and CaO is the weight percent of CaO in the nanocrystalline alumina, wherein the additive ratio is (CaO/MgO) is at least about 0.05 or at least about 0.1 or at least about 0.15 or at least about 0.2 or at least about 0.25.

### Embodiment 33

The coated abrasive article or method of embodiments 1 or 2, wherein the nanocrystalline alumina comprises a rare earth oxide selected from the group consisting of yttrium oxide, cerium oxide, praseodymium oxide, samarium oxide, ytterbium oxide, neodymium oxide, lanthanum oxide, gadolinium oxide, dysprosium oxide, erbium oxide, precursors thereof, and combinations thereof.

### Embodiment 34

The coated abrasive article or method of embodiments 1 or 2, wherein the nanocrystalline alumina comprises a rare earth alumina crystallite.

### Embodiment 35

The coated abrasive article or method of embodiments 1 or 2, wherein the nanocrystalline alumina comprises a spinel material.

### Embodiment 36

The coated abrasive article or method of embodiments 1 or 2, wherein the nanocrystalline material comprises nanocrystalline particles and each particle includes at least about 50 vol % crystalline or polycrystalline material for the total volume of each particle or at least about 75 vol % crystalline or polycrystalline material or at least about 85 vol % crystalline or polycrystalline material or at least about 90 vol % crystalline or polycrystalline material or at least about 95 vol % crystalline or polycrystalline material or wherein each particle consists essentially of crystalline or polycrystalline material.

### Embodiment 37

The coated abrasive article or method of embodiments 1 or 2, wherein the nanocystalline alumina is essentially free of a rare earth oxide and iron.

### Embodiment 38

The coated abrasive article or method of embodiments 1 or 2, wherein the nanocrystalline alumina comprises a rare earth aluminate phase.

### Embodiment 39

The coated abrasive article or method of embodiments 1 or 2, wherein the nanocrystalline alumina comprises a Vickers hardness of at least about 18 GPa or at least about 18.5 GPa or at least 19 GPa or at least about 19.5 GPa.

### Embodiment 40

The coated abrasive article or method of embodiments 1 or 2, wherein the nanocrystalline alumina comprises a density of at least about 3.85 g/cc or at least about 3.9 g/cc or at least about 3.94 g/cc.

### Embodiment 41

The coated abrasive article or method of embodiments 1 or 2, wherein the abrasive particles include a blend including a first type of abrasive particle including the nanocrystalline alumina and a second type of abrasive particle selected from the group consisting of oxides, carbides, nitrides, borides, oxycarbides, oxynitrides, superabrasives, carbon-based materials, agglomerates, aggregates, shaped abrasive particles, and a combination thereof.

### Embodiment 42

The coated abrasive article or method of embodiments 1 or 2, wherein the abrasive particles comprising nanocrystalline alumina are non-agglomerated particles.

### Embodiment 43

The coated abrasive article or method of embodiments 1 or 2, wherein the abrasive particles comprising nanocrystalline alumina are agglomerated particles.

### Embodiment 44

The coated abrasive article or method of embodiments 1 or 2, wherein at least a portion of the abrasive particles comprising nanocrystalline alumina are shaped abrasive particles.

### Embodiment 45

The coated abrasive article or method of embodiment 44, wherein the shaped abrasive particles comprise a two dimensional shape selected from the group consisting of regular polygons, irregular polygons, irregular shapes, triangles, partially-concave triangles, quadrilaterals, rectangles, trapezoids, pentagons, hexagons, heptagons, octagons, ellipses, Greek alphabet characters, Latin alphabet characters, Russian alphabet characters, and a combination thereof.

### Embodiment 46

The coated abrasive article or method of embodiment 44, wherein the shaped abrasive particles comprise a three-dimensional shape selected from the group consisting of a polyhedron, a pyramid, an ellipsoid, a sphere, a prism, a cylinder, a cone, a tetrahedron, a cube, a cuboid, a rhombohedrun, a truncated pyramid, a truncated ellipsoid, a truncated sphere, a truncated cone, a pentahedron, a hexahedron, a heptahedron, an octahedron, a nonahedron, a decahedron, a Greek alphabet letter, a Latin alphabet character, a Russian alphabet character, a Kanji character, complex polygonal shapes, irregular shaped contours, a volcano shape, a monostatic shape, and a combination thereof, a monostatic shape is a shape with a single stable resting position.

### Embodiment 47

The coated abrasive article or method of embodiment 44, wherein the shaped abrasive particles comprises a partially-concave triangular two-dimensional shape.

### Embodiment 48

The coated abrasive article or method of embodiment 44, wherein each of the shaped abrasive particles have body including a body length (Lb), a body width (Wb), and a body thickness (Tb), and wherein Lb>Wb, Lb>Tb, and Wb>Tb.

### Embodiment 49

The coated abrasive article or method of embodiment 48, wherein the body comprises a primary aspect ratio (Lb:Wb) of at least about 1:1 or at least about 2:1 or at least about 3:1 or at least about 5:1 or at least about 10:1, and not greater than about 1000:1.

### Embodiment 50

The coated abrasive article or method of embodiment 48, wherein the body comprises a secondary aspect ratio (Lb:Tb) of at least about 1:1 or at least about 2:1 or at least about 3:1 or at least about 5:1 or at least about 10:1, and not greater than about 1000:1.

### Embodiment 51

The coated abrasive article or method of embodiment 48, wherein the body comprises a tertiary aspect ratio (Wb:Tb) of at least about 1:1 or at least about 2:1 or at least about 3:1 or at least about 5:1 or at least about 10:1, and not greater than about 1000:1.

### Embodiment 52

The coated abrasive article or method of embodiment 48, wherein at least one of the body length (Lb), the body width (Wb), and the body thickness (Tb) has an average dimension of at least about 0.1 microns or at least about 1 micron or at least about 10 microns or at least about 50 microns or at least about 100 microns or at least about 150 microns or at least about 200 microns or at least about 400 microns or at least about 600 microns or at least about 800 microns or at least about 1 mm, and not greater than about 20 mm or not greater than about 18 mm or not greater than about 16 mm or not greater than about 14 mm or not greater than about 12 mm or not greater than about 10 mm or not greater than about 8 mm or not greater than about 6 mm or not greater than about 4 mm.

### Embodiment 53

The coated abrasive article or method of embodiment 48, wherein the body comprises a cross-sectional shape in a plane defined by the body length and the body width selected from the group consisting of triangular, quadrilateral, rectangular, trapezoidal, pentagonal, hexagonal, heptagonal, octagonal, ellipsoids, Greek alphabet characters, Latin alphabet characters, Russian alphabet characters, and a combination thereof.

### Embodiment 54

The coated abrasive article or method of embodiment 48, wherein the body comprises a cross-sectional shape in a plane defined by the body length and the body thickness selected from the group consisting of triangular, quadrilateral, rectangular, trapezoidal, pentagonal, hexagonal, heptagonal, octagonal, ellipsoids, Greek alphabet characters, Latin alphabet characters, Russian alphabet characters, and a combination thereof.

### Embodiment 55

The coated abrasive article or method of embodiment 48, wherein the body is essentially free of a binder.

### Embodiment 56

The coated abrasive article or method of embodiment 48, wherein the body is essentially free of an organic material.

### Embodiment 57

The coated abrasive article or method of embodiment 48, wherein the body includes a polycrystalline material.

### Embodiment 58

The coated abrasive article or method of embodiment 44, wherein the shaped abrasive particles are arranged in a controlled distribution on the substrate.

### Embodiment 59

The coated abrasive article or method of embodiment 44, wherein the shaped abrasive particles have a controlled orientation including at least one of a predetermined rotational orientation, a predetermined lateral orientation, and a predetermined longitudinal orientation.

### Embodiment 60

The coated abrasive article or method of embodiment 44, wherein a majority of the shaped abrasive particles are coupled to the substrate in a side orientation, wherein at least about 55% of the shaped abrasive particles of the plurality of shaped abrasive particles are coupled to the substrate in a side orientation, at least about 60%, at least about 65%, at least about 70%, at least about 75%, at least about 77%, at least about 80%, and not greater than about 99%, not greater than about 95%, not greater than about 90%, not greater than about 85%.

### Embodiment 61

The coated abrasive article or method of embodiment 48, wherein the abrasive particles define a batch having a first portion and a second portion, and wherein the abrasive particles of the first portion are different from the abrasive particles of the second portion by at least one characteristic selected from the group consisting of two-dimensional shape, average particle size, particle color, hardness, friability, toughness, density, specific surface area, or any combination thereof.

### Embodiment 62

The coated abrasive article or method of embodiment 61, wherein the first portion comprises a majority of a total of abrasive particles of the batch.

### Embodiment 63

The coated abrasive article or method of embodiment 61, wherein the first portion comprises a minority of a total of abrasive particles of the batch.

### Embodiment 64

The coated abrasive article or method of embodiment 61, wherein the first portion defines at least 1% of a total of abrasive particles of the batch.

### Embodiment 65

The coated abrasive article or method of embodiment 61, wherein the first portion defines not greater than about 99% of a total of abrasive particles of the batch.

### Embodiment 66

The coated abrasive article or method of embodiment 61, wherein the second portion comprises diluent abrasive particles.

### Embodiment 67

The coated abrasive article or method of embodiment 61, wherein the second portion comprises abrasive particles having a larger average grain size compared to the abrasive particles of the first portion comprising the nanocrystalline alumina.

### Embodiment 68

The coated abrasive article or method of embodiments 1 or 2, wherein the abrasive particles are arranged in a controlled distribution on the substrate.

### Example 1

Vickers hardness of representative MCA (i.e., microcrystalline alumina) samples and NCA (i.e., nanocrystalline alumina) samples was measured. The MCA abrasive particles and the NCA abrasive particles were obtained from Saint-Gobain Corporation. The MCA abrasive particles are available as Cerpass® HTB. The crystallite sizes of the nanocrystalline alumina and the microcrystalline alumina are about 0.1 microns and 0.2 microns, respectively. The samples of MCA abrasive particles and NCA abrasive particles were prepared in the same manner. Vickers hardness of 5 samples of MCA abrasive particles and NCA abrasive particles were tested. The average Vickers hardness of the MCA abrasive particles and the NCA abrasive particles is disclosed in Table 2.

The relative friability of the NCA abrasive particles was measured in accordance with the procedures disclosed herein. The MCA and NCA samples had grit size 80, and the MCA abrasive particles were used as the standard sample. The ball milling time was 6 minutes. As disclosed in Table 2, the relative friability of the MCA abrasive particles is set as 100%, and the NCA abrasive particles demonstrated Vickers hardness very similar to that of MCA abrasive particles, but had relative friability of 123%.

TABLE 2

| | MCA | NCA |
|---|---|---|
| Hardness (GPa) | 21.8 | 21.4 |
| Relative Friability | 100% | 123% |

The present embodiments represent a departure from the state of the art. While some patent publications have remarked that microcrystalline alumina can be made to have submicron average crystallite sizes, those of skill in the art recognize that commercially available forms of microcrystalline alumina have an average crystallite size of between approximately 0.18 to 0.25 microns. To the Applicants knowledge, alumina-based abrasives having finer average crystallite sizes are not publically available and methods for forming such abrasive particles are not actually enabled. Furthermore, in view of the discovery that Vickers hardness of MCA and NCA abrasive particles had essentially no distinction, one of ordinary skill in the art might not expect a significant difference in the performance of a coated abrasive article utilizing the NCA abrasive particles. However, certain applications using the NCA grains in coated abrasive articles may yet prove to be unexpected and remarkable.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

The Abstract of the Disclosure is provided to comply with Patent Law and is submitted with the understanding that it will not be used to interpret or limit the scope or meaning of the claims. In addition, in the foregoing Detailed Description of the Drawings, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all features of any of the disclosed embodiments. Thus, the following claims are incorporated into the Detailed Description of the Drawings, with each claim standing on its own as defining separately claimed subject matter.

What is claimed is:

1. A coated abrasive article comprising:
a substrate;
a bond material overlying the substrate; and
a layer of abrasive particles contained within the bond material, the abrasive particles comprising nanocrystalline alumina.

2. The coated abrasive article of claim 1, wherein the abrasive particles comprise nanocrystalline alumina having an average crystallite size of at least 0.05 microns and not greater than 0.14 microns.

3. The coated abrasive article of claim 1, wherein the nanocrystalline alumina comprises at least about 51 wt % alumina and not greater than about 99 wt % alumina for the total weight of the particles.

4. The coated abrasive article of claim 1, wherein the nanocrystalline alumina comprises at least one additive selected from the group consisting of a transition metal element, a rare-earth element, an alkali metal element, an alkaline earth metal element, silicon, and a combination thereof.

5. The coated abrasive article of claim 4, wherein the nanocrystalline alumina comprises a total content of additive of at least 1 wt % and not greater than about 12 wt % for a total weight of the nanocrystalline alumina particles.

6. The coated abrasive article of claim 4, wherein the additive includes magnesium oxide (MgO).

7. The coated abrasive article of claim 6, wherein the nanocrystalline alumina comprises at least about 0.4 wt % MgO and not greater than about 5 wt % MgO for a total weight of the nanocrystalline alumina.

8. The coated abrasive article of claim 6, wherein the additive includes zirconium oxide (ZrO₂).

9. The coated abrasive article of claim 8, wherein the nanocrystalline alumina comprises at least about 0.1 wt % ZrO₂ and not greater than about 8 wt % ZrO₂ for a total weight of the nanocrystalline alumina.

10. The coated abrasive article of claim 9, wherein the nanocrystalline alumina comprises an additive ratio (MgO/ZrO₂) of at least 0.1 and not greater than 1.5.

11. The coated abrasive article of claim 4, wherein the additive includes calcium oxide (CaO).

12. The coated abrasive article of claim 11, wherein the nanocrystalline alumina comprises at least 0.01 wt % CaO and not greater than 5 wt % CaO for a total weight of the nanocrystalline alumina.

13. The coated abrasive article of claim 11, wherein the additive includes magnesium oxide (MgO) and calcium oxide (CaO) and wherein the nanocrystalline alumina comprises an additive ratio (CaO/MgO) of at least 0.01 and not greater than 1.

14. The coated abrasive article of claim 1, wherein the nanocrystalline alumina comprises a rare earth oxide selected from the group consisting of yttrium oxide, cerium oxide, praseodymium oxide, samarium oxide, ytterbium oxide, neodymium oxide, lanthanum oxide, gadolinium oxide, dysprosium oxide, erbium oxide, precursors thereof, and combinations thereof.

15. The coated abrasive article of claim 1, wherein the nanocrystalline alumina comprises a Vickers hardness of at least about 18 GPa or at least about 18.5 GPa or at least 19 GPa or at least about 19.5 GPa.

16. The coated abrasive article of claim 1, wherein the abrasive particles include a blend including a first type of abrasive particle including the nanocrystalline alumina and a second type of abrasive particle selected from the group consisting of oxides, carbides, nitrides, borides, oxycarbides, oxynitrides, superabrasives, carbon-based materials, agglomerates, aggregates, shaped abrasive particles, and a combination thereof.

17. The coated abrasive article of claim 1, wherein at least a portion of the abrasive particles comprising nanocrystalline alumina are shaped abrasive particles.

18. The coated abrasive article of claim 17, wherein the shaped abrasive particles comprise a two dimensional shape selected from the group consisting of regular polygons, irregular polygons, irregular shapes, triangles, partially-concave triangles, quadrilaterals, rectangles, trapezoids, pentagons, hexagons, heptagons, octagons, ellipses, Greek alphabet characters, Latin alphabet characters, Russian alphabet characters, and a combination thereof.

19. The coated abrasive article of claim 17, wherein the shaped abrasive particles comprise a three-dimensional shape selected from the group consisting of a polyhedron, a pyramid, an ellipsoid, a sphere, a prism, a cylinder, a cone, a tetrahedron, a cube, a cuboid, a rhombohedrun, a truncated pyramid, a truncated ellipsoid, a truncated sphere, a truncated cone, a pentahedron, a hexahedron, a heptahedron, an octahedron, a nonahedron, a decahedron, a Greek alphabet letter, a Latin alphabet character, a Russian alphabet character, a Kanji character, complex polygonal shapes, irregular shaped contours, a volcano shape, a monostatic shape, and a combination thereof, a monostatic shape is a shape with a single stable resting position.

20. The coated abrasive article or method of claim 1, wherein the abrasive particles are arranged in a controlled distribution on the substrate.
